(19) United States
(12) Patent Application Publication
(10) Pub. No.: US 2003/0090756 A1
(43) Pub. Date: May 15, 2003

(54) Optical channel monitor having an array of micro-mirrors

(75) Inventors: John A. Moon, Wallingford, CT (US); Alan D. Kersey, S. Glastonbury, CT (US); Jay W. Dawson, Livermore, CA (US); James R. Dunphy, S. Glastonbury, CT (US); Joseph Pinto, Wallingford, CT (US); Christian O'Keefe, Durham, CT (US); Paul Szczepanek, Middletown, CT (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: CiDRA Corporation, Wallingford, CT

(21) Appl. No.: 10/255,133

(22) Filed: Sep. 25, 2002

Related U.S. Application Data
(63) Continuation-in-part of application No. 10/115,647, filed on Apr. 3, 2002.
(63) Continuation-in-part of application No. 10/120,617, filed on Apr. 11, 2002.
(60) Provisional application No. 60/325,066, filed on Sep. 25, 2001.

(51) Int. Cl. H04B 10/08; H04J 14/02

(52) U.S. Cl. 359/110; 359/127; 359/129; 359/130

(57) ABSTRACT

A reconfigurable optical channel monitor selects and determines a parameter of desired optical channel(s) from and/or to an optical WDM input signal. The OCM includes a spatial light modulator having a micro-mirror device with a two-dimensional array of micro-mirrors that tilt between first and second positions in response to a control signal from a controller in accordance with a switching algorithm and an input command. A collimator, diffraction grating, and Fourier lens collectively converge the optical input channels onto the micro-mirrors array. The optical channel is focused onto a plurality of micro-mirrors. To select each input channel, a group of micro-mirrors associated with each desired input channel is tilted to reflect the desired input channel back along the return path to a photodetector and processing unit to determine a parameter of the selected input signal.

### CROSS REFERENCE TO RELATED APPLICATIONS

This application claims benefit to provisional patent application serial No. 60/325,066 (CC-0396), entitled “Optical Channel Monitor Having an Array of Micromirrors”, filed Sep. 25, 2001, and is a continuation-in-part of patent application Ser. No. 10/115,647 (CC-0461), filed Apr. 3, 2002, as well as a continuation-in-part of patent application Ser. No. 10/120,617 (CC-0461), filed Apr. 11, 2002, which are all hereby incorporated by reference in their entirety.

This application filed concurrently with the same identified by Express mail nos. EV 137 071 802 US (CC-0544), EV 137 071 816 US (CC-0546) and EV 137 071 780 US (CC-0547), which are also hereby incorporated by reference in their entirety.

### BACKGROUND OF THE INVENTION

1. Technical Field

The present invention relates to a tunable optical device, and more particularly to an Optical Channel Monitor (OCM) including an array of micro-mirrors to select and determine a parameter of an optical channel of a WDM optical input signal.

2. Description of Related Art

MEMS micro-mirrors have been widely explored and used for optical switching applications. The most commonly used application is for optical cross-connect switching. In most cases, individual micro-mirror elements are used to ‘steer’ a beam (i.e., an optical channel) to a switched port or to deflect the beam to provide attenuation on a channel-by-channel basis. Each system is designed for a particular ‘wavelength plan’—e.g. “X” number of channels at a spacing “Y”, and therefore each system is not ‘scalable’ to other wavelength plans.

In the networking systems, it is often necessary to route different channels (i.e., wavelengths) between one fiber and another using a reconfigurable optical add/drop multiplexer (ROADM) and/or an optical cross-connect device. Many technologies can be used to accomplish this purpose, such as Bragg gratings or other wavelength selective filters.

One disadvantage of Bragg grating technology is that it requires many discrete gratings and/or switches, which makes a 40 or 80 channel device quite expensive. A better alternative would be to use techniques well known in spectroscopy to spatially separate different wavelengths or channels using bulk diffraction grating technology. For example, each channel of an ROADM is provided to a different location on a generic micro-electro-mechanical system (MEMS) device. The MEMs device is composed of a series of tilting mirrors, where each discrete channel hits near the center of a respective mirror and does not hit the edges. In other words, one optical channel reflects off a single respective mirror.

One issue with the above optical MEMs device is that it is not “channel plan independent”. In other words, each MEMs device is limited to the channel spacing (or channel plan) originally provide. Another concern is that if the absolute value of a channel wavelength changes, a respective optical signal may begin to hit an edge of a corresponding mirror leading to large diffraction losses. Further, since each channel is aligned to an individual mirror, the device must be carefully adjusted during manufacturing and kept in alignment when operated through its full temperature range in the field.

It would be advantageous to provide an optical channel monitor (OCM) that mitigates the above problems by using an array of micro-mirrors.

### SUMMARY OF THE INVENTION

An object of the present invention is to provide an optical channel monitor (OCM) having a spatial light modulator that includes a micro-mirror device having an array of micro-mirrors, wherein a plurality of micro-mirrors direct the optical channels of the WDM input signal to select and determine a parameter of an input channel from the optical WDM input signal.

In accordance with an embodiment of the present invention, the optical channel monitor has an optical arrangement and a single light detector. The optical arrangement has one or more light dispersion element and a spatial light modulator. The one or more light dispersion elements separate one or more optical signals into optical bands or channels and combines one or more reflected optical bands or channels into a combined optical signal. The spatial light modulator has a micro-mirror device with an array of micro-mirrors, a respective combination of rows and columns of micro-mirrors selectively reflecting one or more optical bands or channels. The single light detector detects the one or more reflected optical bands or channels in the combined optical signal.

The one or more light dispersion elements may include either a diffraction grating, an optical splitter, a holographic device, a prism, or a combination thereof. The one or more diffraction gratings may include a blank of polished fused silica or glass with a reflective coating having a plurality of grooves either etched, ruled or suitably formed thereon. The diffraction grating may also be tilted and rotated approximately 90 degree in relation to the spatial axis of the spatial light modulator.

The spatial light modulator is a DMD that may be programmable for reconfiguring the optical channel monitor by changing a switching algorithm that drives the array of micro-mirrors.

In one embodiment, the optical channel monitor includes a first collimator that collimates an optical input signal. The optical input signal comprises a plurality of optical input channels, each of which are centered at a central wavelength. A first light dispersion element substantially separates the optical input channels of the collimated optical input signal. A spatial light modulator reflects each separated optical input channel along a respective first optical path or second optical path in response to a control signal. The spatial light modulator includes a micro-mirror device that has an array of micro-mirrors selectively disposable between a first and a second position in response to the control signal. Each separated optical input channel is incident on a respective group of micro-mirrors. Each respective separated optical input channel reflects along the respective first optical path when the micro-mirrors are disposed in the first position, or along the respective second optical path when the micro-mirrors are disposed in the second position. A controller generates the control signal in accordance with a switching algorithm.

### BRIEF DESCRIPTION OF THE DRAWING

The drawing, which is not drawn to scale, includes the following Figures:

FIG. 1 is a plan view of a block diagram of an optical channel monitor (OCM) including a spatial light modulator in accordance with the present invention;

FIG. 2 is a side elevational view of a block diagram of the OCM of FIG. 1;

FIG. 3 is a block diagram of a spatial light modulator of the OCM of FIG. 1 having a micro-mirror device, wherein the optical channels of a WDM input signal are distinctly projected onto the micro-mirror device, in accordance with the present invention;

FIG. 4a is a pictorial cross-sectional view of the micro-mirror device of FIG. 3 showing a partial row of micro-mirrors, when the micro-mirrors are disposed in a first position perpendicular to the light beam of the input signal in accordance with the present invention;

FIG. 4b is a pictorial cross-sectional view of the micro-mirror device of FIG. 3 showing a partial row of micro-mirrors, when the micro-mirrors are disposed in a second position non-orthogonal to the light beam of the input signal in accordance with the present invention;

FIG. 5 is a plan view of a micro-mirror of the micro-mirror device of FIG. 3 in accordance with the present invention;

FIG. 6 is a block diagram of a spatial light modulator of the OCM of FIG. 3, wherein groups of micro-mirrors are tilted to select/filter an optical channel from the WDM input signal, in accordance with the present invention;

FIG. 7 is a block diagram of another embodiment of an OCM including a spatial light modulator, in accordance with the present invention;

FIG. 8 is a diagram showing filter function of the OCM and an OCA similar to the OCM of FIG. 1, in accordance with the present invention;

FIG. 9 is a plot showing output signal of an OCA similar to the OCM of FIG. 1, in accordance with the present invention;

FIG. 10 is a block diagram of another embodiment of an OCM including a spatial light modulator, in accordance with the present invention.

FIG. 11 is a block diagram of a spatial light modulator of the OCM of FIG. 10 having a micro-mirror device, wherein the optical channels of a WDM input signal are distinctly projected onto the micro-mirror device, in accordance with the present invention;

FIG. 12 is a block diagram of a spatial light modulator of the OCM of FIG. 10, wherein groups of micro-mirrors are tilted to select/filter an optical channel from the WDM input signal, in accordance with the present invention;

FIG. 13 is a perspective view of a portion of a known micro-mirror device;

FIG. 14 is a plan view of a micro-mirror of the micro-mirror device of FIG. 13;

FIG. 15a is a pictorial cross-sectional view of the micro-mirror device of FIG. 13 showing a partial row of micro-mirrors, when the micro-mirrors are disposed in a second position non-orthogonal to the light beam of the input signal in accordance with the present invention;

FIG. 15b is a pictorial cross-sectional view of the micro-mirror device of FIG. 13 showing a partial row of micro-mirrors, when the micro-mirrors are disposed in a first position perpendicular to the light beam of the input signal in accordance with the present invention;

FIG. 16 is a pictorial cross-sectional view of the micro-mirror device of FIG. 13 disposed at a predetermined angle in accordance with the present invention;

FIG. 17 is a graphical representation of the micro-mirror device of FIG. 16 showing the reflection of the incident light;

FIG. 18 is a graphical representation of the micro-mirror device of FIG. 16 and a light dispersion element in accordance with the present invention;

FIG. 19 is a plan view of a block diagram of another embodiment of an OCM including a spatial light modulator in accordance with the present invention;

FIG. 20 is an expanded view of the micro-mirror device of the spatial light modulator of FIG. 19, wherein the optical channels of a WDM input signal are distinctly projected onto the micro-mirror device, in accordance with the present invention;

FIG. 21 is a graphical representation of the light of an optical channel reflecting off a spatial light modulator, wherein the light is focused relatively tight, in accordance with the present invention;

FIG. 22 is a graphical representation of the light of an optical channel reflecting off a spatial light modulator, wherein the light is focused relatively loose compared to that shown in FIG. 17, in accordance with the present invention;

FIG. 23 is a block diagram of another embodiment of an OCM including a plurality of OCMs using a single spatial light modulator, in accordance with the present invention;

FIG. 24 is a block diagram of the spatial light modulator of the OCM of FIG. 23, wherein the optical channels of a plurality of WDM input signals are distinctly projected onto the micro-mirror device, in accordance with the present invention;

FIG. 25 is a block diagram of the spatial light modulator of the OCM of FIG. 23, wherein the optical channels of a plurality of WDM input signals are distinctly projected onto the micro-mirror device, in accordance with the present invention;

FIG. 26 is a block diagram of a spatial light modulator of the OCM of FIG. 23, wherein groups of micro-mirrors are tilted to select respective input channels from the plurality of WDM input signals, in accordance with the present invention;

FIG. 27 is a block diagram of a dual pass OCM including a spatial light modulator, in accordance with the present invention;

FIG. 28 is a block diagram of the spatial light modulator of the OCM of FIG. 27, wherein the optical channels of a plurality of WDM input signals are distinctly projected onto the micro-mirror device, in accordance with the present invention;

FIG. 29 is a block diagram of another embodiment of an OCM including a spatial light modulator, in accordance with the present invention;

FIG. 30A is a plot showing filter function of a single pass OCM, a filter function of a dual pass OCM and the noise level of the OCM, in accordance with the present invention;

FIG. 30B is a plan view of a block diagram of another embodiment of an OCM in accordance with the present invention;

FIG. 31 is a block diagram of another embodiment of an OCM including a spatial light modulator, in accordance with the present invention;

FIG. 32 is a block diagram of another embodiment of an OCM including a spatial light modulator, in accordance with the present invention;

FIG. 33A is an exploded view of a collimator assembly according to the present invention;

FIG. 33B is an exploded view of a fiber array holder subassembly that forms part of the collimator assembly shown in FIG. 33A;

FIGS. 33C and 33D are exploded views of a fiber V-groove subassembly shown in FIG. 33B;

FIG. 33E is a view of a constructed collimator assembly shown in FIG. 33A;

FIG. 34 shows an alternative embodiment of an optical channel monitor one or more optic devices for minimizing polarization dispersion loss (PDL);

FIG. 35 shows an embodiment of a channel monitor having a chisel prism in accordance with the present invention;

FIG. 36 shows an alternative embodiment of a channel monitor having a chisel prism in accordance with the present invention;

FIG. 37 shows an alternative embodiment of a channel monitor having a chisel prism in accordance with the present invention; and

FIG. 38 is side elevational view of a portion of the optical channel filter of FIG. 37.

### BEST MODE FOR CARRYING OUT THE INVENTION

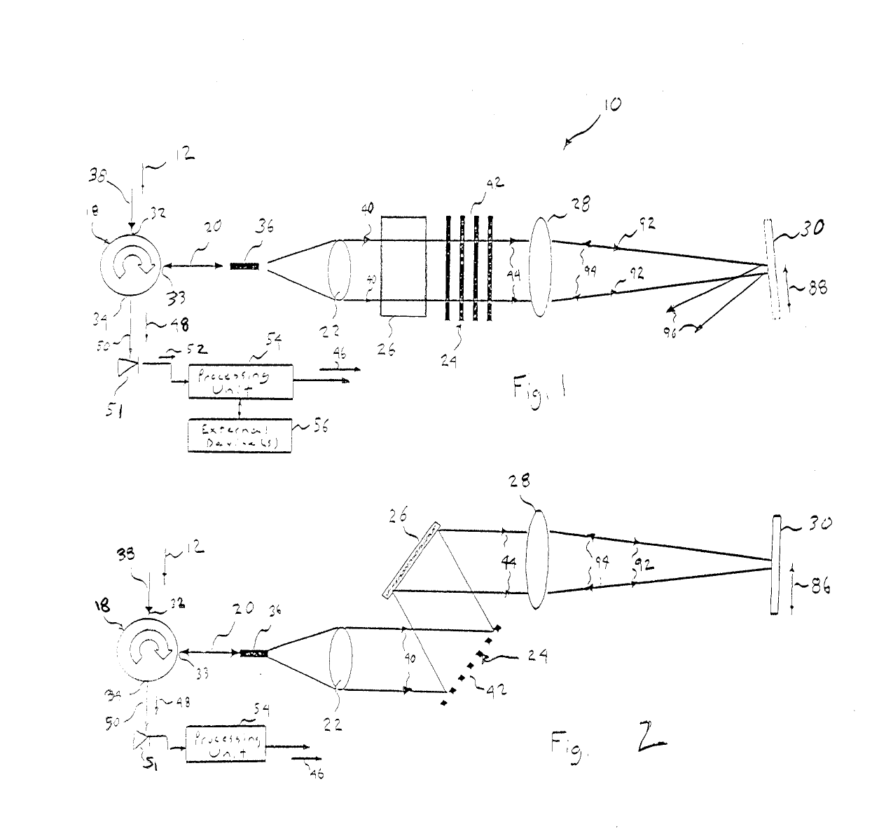

FIGS. 1-6 show an embodiment of the basic invention which features an optical channel monitor generally indicated as 10 having an optical arrangement and a single light detector 51. The optical arrangement has a light dispersion element 24 and a spatial light modulator 30. The light dispersion element 24 separates an optical signal into optical bands or channels. The spatial light modulator has a micro-mirror device 82 with an array of micro-mirrors 84, a respective combination of rows and columns 100 (FIG. 6) of micro-mirrors selectively reflecting one or more optical bands or channels. The single light detector 51 detects the one or more reflected optical bands or channels in the optical input signal.

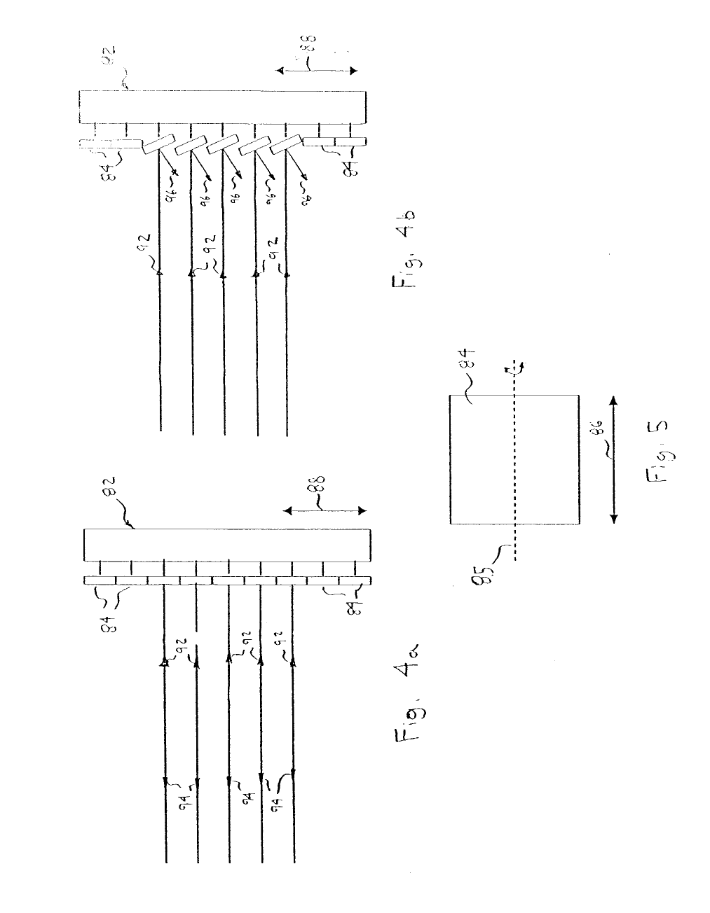

In FIGS. 1-3, the OCM 10 selects a desired optical channel 14 of light (i.e., a wavelength band) or group of optical channels from an optical WDM input signal 12 and determines a parameter of the selected optical channel. Each of the optical channels 14 (see FIG. 3) of the input signal 12 is centered at a respective channel wavelength (λ₁, λ₂, λ₃, . . . , λ_{N}).

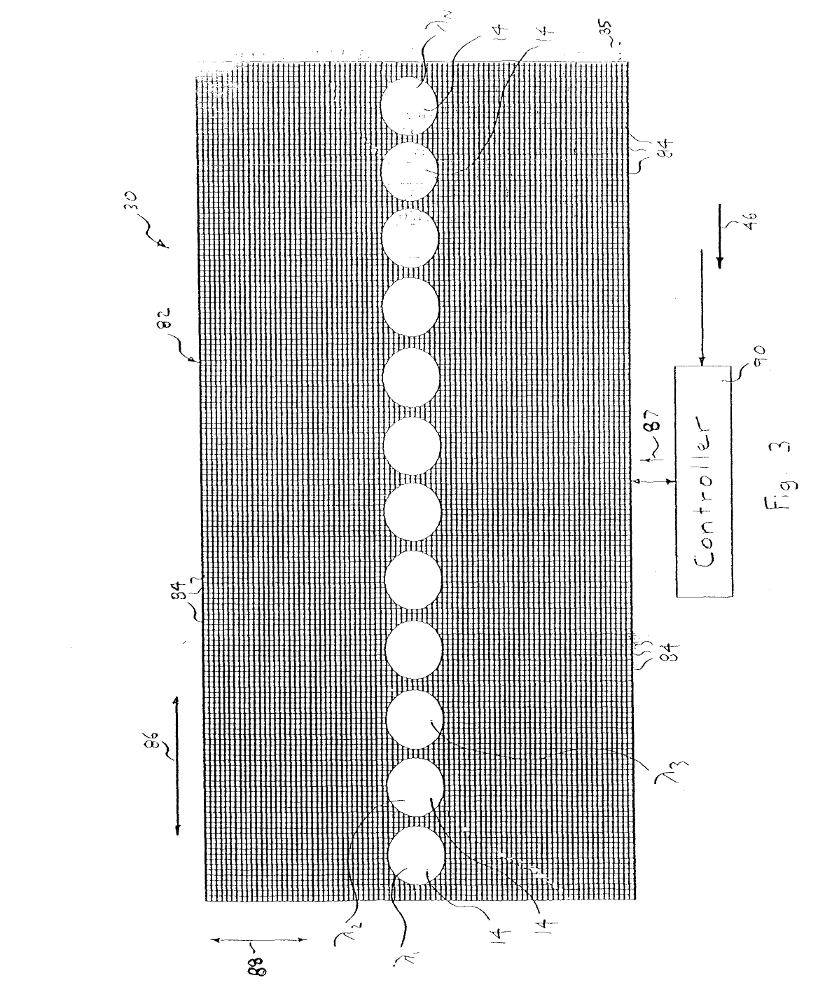

FIG. 1 is a plan view of the OCM 10. To better understand the OCM 10 of FIG. 1, a side elevational view of the OCM is illustrated in FIG. 2. As shown in FIG. 2, the optics of the OCM 10 is disposed in two tiers or horizontal planes. Specifically, the OCM includes a three-port circulator 18, an optical fiber or pigtail 20, a collimator 22, a light dispersive element 24, a mirror 26, and a bulk lens 28 for directing light to and from a spatial light modulator 30. As shown, the pigtail 20, the collimator 22 and the light dispersive element 24 are disposed in a first tier or horizontal plane. The mirror 26, bulk lens 28 and the spatial light modulator 30 are disposed in the second tier or second horizontal plane which is substantially parallel to the first horizontal plane.

Referring to FIGS. 1 and 2, the three-port circulator 18 directs light from a first port 32 to a second port 33 and from the second port to a third port 34. The optical fiber or pigtail 20 is optically connected to the second port of the circulator 18. A capillary tube 36, which may be formed of glass, is attached to one end of the pigtail 20 such as by epoxying or collapsing the tube onto the pigtail. The circulator 18 at the first port 32 receives the WDM input signal 12 tapped from an optical network (not shown) via optical fiber 38, and directs the input light to the pigtail 20. The input signal 12 exits the pigtail (into free space) and passes through the collimator 22, which collimates the input signal. The collimator 22 may be an aspherical lens, an achromatic lens, a doublet, a GRIN lens, a laser diode doublet or similar collimating lens. The collimated input signal 40 is incident on the light dispersion element 24 (e.g., a diffraction grating or a prism), which separates spatially the optical channels of the collimated input signal 40 by diffracting or dispersing the light from (or through) the light dispersion element.

In one embodiment, the diffraction grating 24 is comprised of a blank of polished fused silica or glass with a reflective coating (such as evaporated gold or aluminum), wherein a plurality of grooves 42 (or lines) are etched, ruled or otherwise formed in the coating. The diffractive grating 24 has a predetermined number of lines, such as 600 lines/mm, 850 lines/mm and 1200 lines/mm. The resolution of the OCM improves as the number of lines/mm in the grating increases. The grating 24 may be similar to those manufactured by Thermo RGL, part number 3325FS-660 and by Optometrics, part number 3-9601. Alternatively, the diffraction grating may be formed using holographic techniques, as is well known in the art. Further, the light dispersion element may include a prism or optical splitter to disperse the light as the light passes therethrough, or a prism having a reflective surface or coating on its backside to reflect the dispersed light.

As best shown in FIG. 2, the diffraction grating 24 directs the separated light 44 to the mirror 26 disposed in the second tier. The mirror 26 reflects the separated light 44 to the bulk lens 28 (e.g., a Fourier lens), which focuses the separated light onto the spatial light modulator 30, as shown in FIG. 3. In response to a switching algorithm and input command 46, the spatial light modulator 30 reflects one optical input channel (i.e., the selected input channel) back through the same optical path to the pigtail 20 as indicated by arrows 94, and reflects the remaining optical input channels (i.e., the dropped channels) away from the bulk lens 28 as indicated by arrows 96, as best shown in FIG. 1A. The selected input channel propagates from the second port 33 to the third port 34 of the optical circulator 18 to provide an output signal 48 from optical fiber 50 to a photodetector 51. The photodetector provides a sensed signal 52, indicative of a parameter of the selected optical channel (e.g., channel power) to a processing unit 54, which interfaces with an external device(s) 56.

The OCM 10 in accordance with the switching algorithm and input command may flip the micro-mirrors of the spatial light modulator 30 to sequentially or selectively direct an input channel 14 to the photodetector 51.

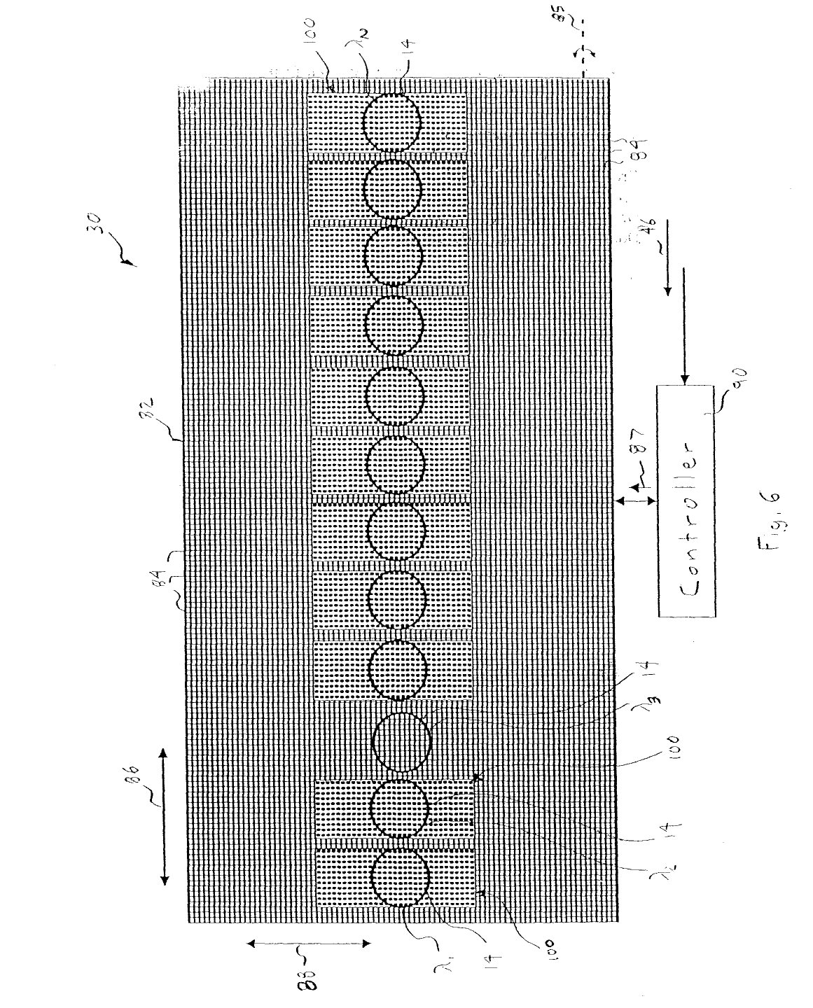

As shown in FIG. 3, the spatial light modulator 30 comprises a micro-mirror device 82 having a two-dimensional array of micro-mirrors 84, which cover a surface of the micro-mirror device. The micro-mirrors 84 are generally square and typically 14-20 μm wide with 1 μm spaces between them. FIG. 4a illustrates a partial row of micro-mirrors 84 of the micro-mirror device 82, when the micro-mirrors are disposed in a first position to reflect the light back along the return path 94 and provide the selected input channel 14 to the optical fiber 50. FIG. 4b illustrates a partial row of micro-mirrors 84 when the micro-mirrors are disposed in a second position, and therefore drop the corresponding input channels 14 along optical path 96, as will be described in greater detail hereinafter. The micro-mirrors may operate in a “digital” fashion. In other words, as the micro-mirrors either lie flat in a first position, as shown in FIG. 4a, or be tilted, flipped or rotated to a second position, as shown in FIG. 4b.

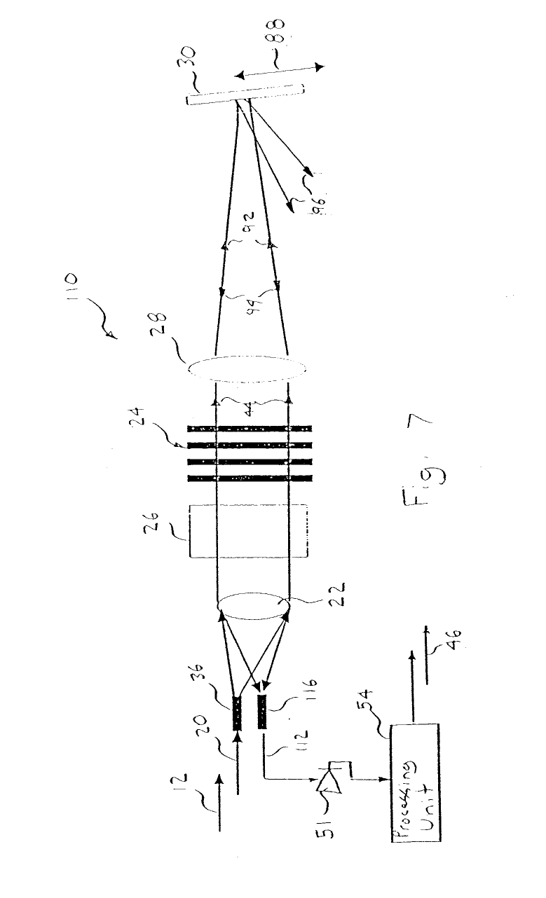

As described herein before, the positions of the mirrors, either flat or tilted, are described relative to the optical path 92 wherein “flat” refers to the mirror surface positioned orthogonal to the optical path, either coplanar in the first position or parallel as will be more fully described hereinafter. The micro-mirrors flip about an axis 85 parallel to the spectral axis 86, as shown in FIGS. 3 and 5, wherein the spectral axis is defined by the direction the channels of the optical input signal 12 is spread by the diffraction grating 24. One will appreciate, however, that the micromirrors may flip about any axis, such as parallel to the spatial axis 88, at a 45 degrees angle to the spatial axis, or any desired angle.

Referring to FIG. 3, the micro-mirrors 84 are individually flipped between the first position and the second position in response to a control signal 87 provided by a controller 90 in accordance with a switching algorithm and an input command 46 from the processing unit 54. The switching algorithm may provide a bit (or pixel) map indicative of the state (flat or tilted) of each of the micro-mirrors 84 of the array to return and/or drop the desired optical channel(s) 14 to provide the output signal 48 at optical fiber 50 (see FIG. 1A), and thus requiring a bit map for each configuration of channels to be dropped. Alternatively, each group of mirrors 84, which reflect a respective optical channel 14, may be individually controlled by flipping the group of micro-mirrors to direct the channel along a desired optical path (i.e., return or drop).

As shown in FIGS. 1 and 4a, the micro-mirror device 82 is oriented to reflect the focused light 92 of the input signal 12 back through the bulk lens 28 to the pigtail 20, as indicated by arrows 94, to provide the output signal 48, when the micro-mirrors 84 are disposed in the first position. As shown in FIGS. 1 and 4b, the focused light 92 reflects away from the bulk lens 28, as indicated by arrows 96. This “digital” mode of operation of the micro-mirrors advantageously eliminates the need for any type of feedback control for each of the micro-mirrors. The micro-mirrors are either “on” or “off” (i.e., first position or second position), respectively, and therefore, can be controlled by simple binary digital logic circuits.

FIG. 3 further illustrates the outline of the optical channels 14 of the optical input signal 12, which are dispersed off the diffraction grating 24 and focused by the bulk lens 28, onto the array of micro-mirrors 84 of the micro-mirror device 82. Each optical channel 14 is distinctly separated from other channels across the spectrum and has a generally circular cross-section, such that the input channels do not substantially overlap spatially when focused onto the spatial light modulator 30. The optical channels have a circular cross-section to project as much of the beam as possible over a multitude of micro-mirrors 84, while keeping the optical channels separated by a predetermined spacing. One will appreciate though that the diffraction grating 24 and bulk lens 28 may be designed to reflect and focus any input channel or group of input channels with any desired cross-sectional geometry, such as elliptical, rectangular, square, polygonal, etc. Regardless of the cross-sectional geometry selected, the cross-sectional area of the channels 14 should illuminate a plurality of micro-mirrors 84, which effectively pixelates the optical channels. In an exemplary embodiment, the cross sectional area of the input channels 14 is generally circular in shape, whereby the width of the optical channel beam spans over approximately 11 micromirrors.

One will appreciate that while the spacing between the channels are predetermined, the spacing between may be non-uniform. For example, one grouping of channels may be spaced to correspond to a 100 Ghz spacing, and another group of channels may be spaced to correspond to a 50 Ghz spacing.

FIG. 6 is illustrative of the position of the micro-mirrors 84 of the micro-mirror device 82 for selecting the optical channels 14 at λ₃, for example. The outline of each channel 14 is shown to provide a reference to visually locate the group of tilted mirrors 100. As shown, the group of mirrors 100 of the optical channels at λ₁, λ₂, λ₄-λ_{N} are tilted away from the return path 94 to the second position, as indicated by the blackening of the micro-mirrors 84. The group of tilted mirrors 100 provides a generally rectangular shape, but one will appreciate that any pattern or shape may be tilted to drop the desired input channels. Consequently, the input channel at λ₃ is reflected back along the return path 94 and sensed by the photodetector 51. In an exemplary embodiment, the groups of micro-mirrors 100 reflect substantially all the light of the input channels 14, at λ₁, λ₂, λ₄-λ_{N} away from the bulk lens 28 indicated by arrows 96. The micro-mirrors 84 of the selected input channel 14 at λ₃ is flat (i.e., first position), as indicated by the white micro-mirrors, to reflect the light 92 back along the return path 94 to the first pigtail 20, as described hereinbefore.

FIG. 7 shows another exemplary embodiment of an OCM that is substantially similar to the OCM 10 of FIG. 1, and therefore, common components have the same reference numeral. The OCM 110 replaces the circulator 18 of FIG. 1 with a second pigtail 112. The second pigtail 112 has a glass capillary tube 116 attached to one end of the second pigtail. The second pigtail 112 receives the selected input channel reflected from the micro-mirror device back along an optical return path. Specifically, the second pigtail 112 receives the selected input channel 14 reflected back along the return optical path 94 from the spatial light modulator 30.

To accomplish these expected return paths, the spatial light modulator 30 cannot be an image plane of the first pigtail 20 along the spatial axis 88. These conditions can be established by ensuring that the lens system 22 and 28 be astigmatic. In particular, the lens 28 may be a cylindricalized lens with its cylindrical axis parallel to the spatial axis 88. By tilting the spatial light modulator 30, the return path can be displaced to focus at the second pigtail 112.

In another embodiment similar to the OCMs 10, 110 of FIGS. 1, 2 and 7, the mirror 26 of each OCM 10,110 may be eliminated with the bulk lens 28 and the spatial light modulator 30 repositioned to directly receive the light dispersed by the diffraction grating 24.

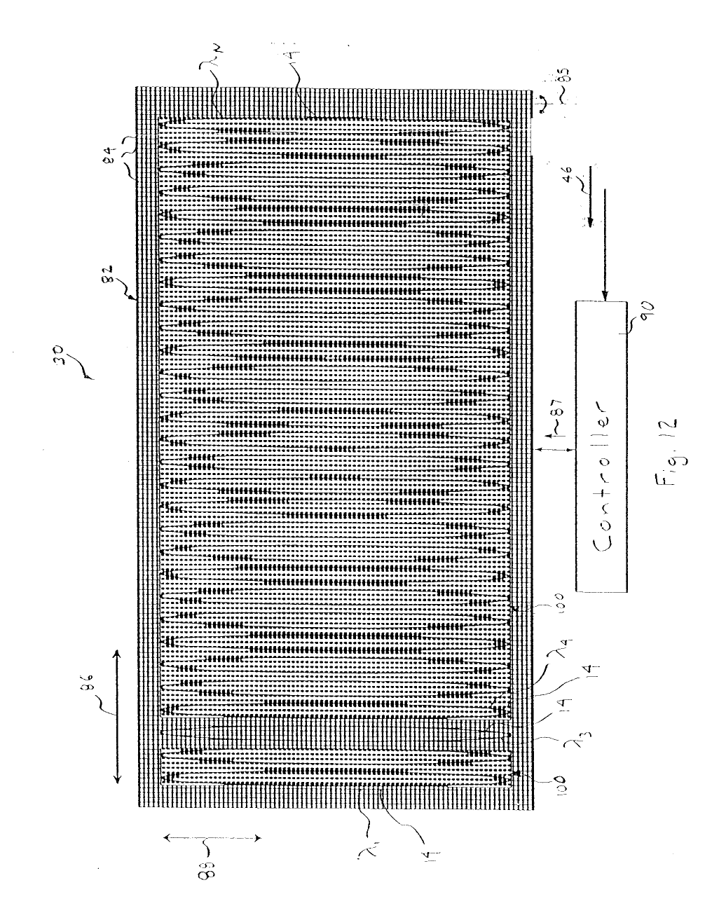

FIG. 10 illustrates another embodiment of an OCM 170 in accordance with the present invention, which is similar to the OCM 10 of FIG. 1, and therefore similar components have the same reference numerals. The OCM 170 is substantially the same as the OCM 10 depicted in FIG. 1, except the optical components of the OCM 170 are disposed in one horizontal plane, rather than two tiers or planes, as shown in FIG. 2. Rather than using a mirror 26 (in FIGS. 1 and 2) to direct the dispersed light 44 to the bulk lens 28 and the spatial light modulator 30, the diffraction grating 24 is tilted to directly disperse the light onto the bulk lens 28 which focuses the light onto the spatial light modulator.

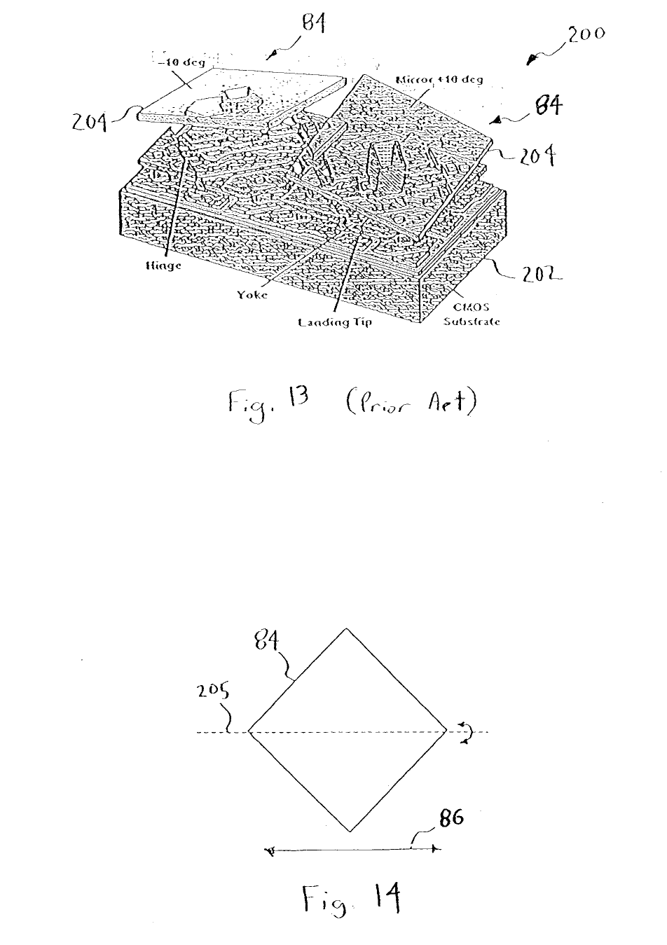

Functionally, the OCM 170 of FIG. 10 and OCM 10 of FIG. 1 are substantially the same. For illustrative purposes however, the collimator 22 and the bulk lens 28 of the OCM 170 may be astigmatic to provide dispersed optical channels 14 incident on the micro-mirror device 82 having a substantially elliptical cross-section, as shown in FIG. 11. Further, the diffraction grating is rotated approximately 90 degrees such that the spectral axis 86 of the optical channels is parallel to the horizontal plane, and the micro-mirror device 82 is similarly rotated approximately 90 degrees such that the spectral axis 86 of the optical channels 14 is perpendicular to the tilt axis 85 of the micro-mirrors 84.

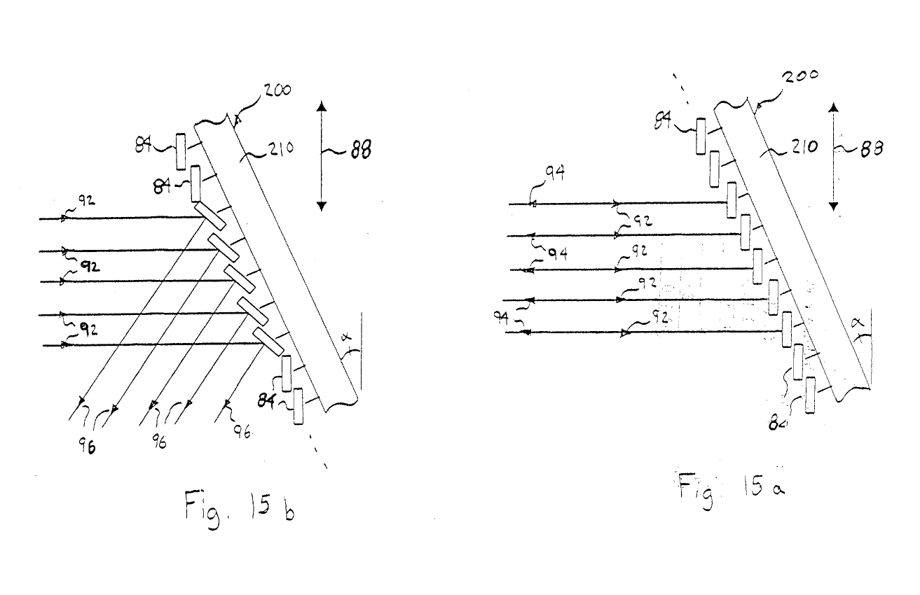

FIG. 12 is illustrative of the position of the micro-mirrors 84 of the micro-mirror device 82 for selecting/filtering the optical input channel 14 at λ₃, for example. The outline of each channel 14 is shown to provide a reference to visually locate the group of tilted mirrors 100. As shown, groups of mirrors 100 associated with the input channels at λ₁, λ₂, λ₄-λ_{N}, are tilted away from the return path to the second position, as indicated by the blackening of the micro-mirrors 84. The groups of tilted mirrors 100 provide a generally rectangular shape, wherein one group of mirrors reflect/drop the input channels 14 at λ₁ and λ₂, and the other group of mirrors reflect/drop the input channels at λ₄-λ_{N}. The micro-mirrors 84 of the selected channel 14 at λ₃ are flat (i.e., first position), as indicated by the white micro-mirrors, to reflect the light back along the return path 94 to the pigtail 22, as described hereinbefore.

The micro-mirror device 82 of FIGS. 1-3 is similar to the Digital Micromirror Device™ (DMD™) manufactured by Texas Instruments and described in the white paper entitled “Digital Light Processing™ for High-Brightness, High-Resolution Applications”, white paper entitled “Lifetime Estimates and Unique Failure Mechanisms of the Digital Micromirror Device (DMD)”, and news release dated September 1994 entitled “Digital Micromirror Display Delivering On Promises of ‘Brighter’ Future for Imaging Applications”, which are incorporated herein by reference.

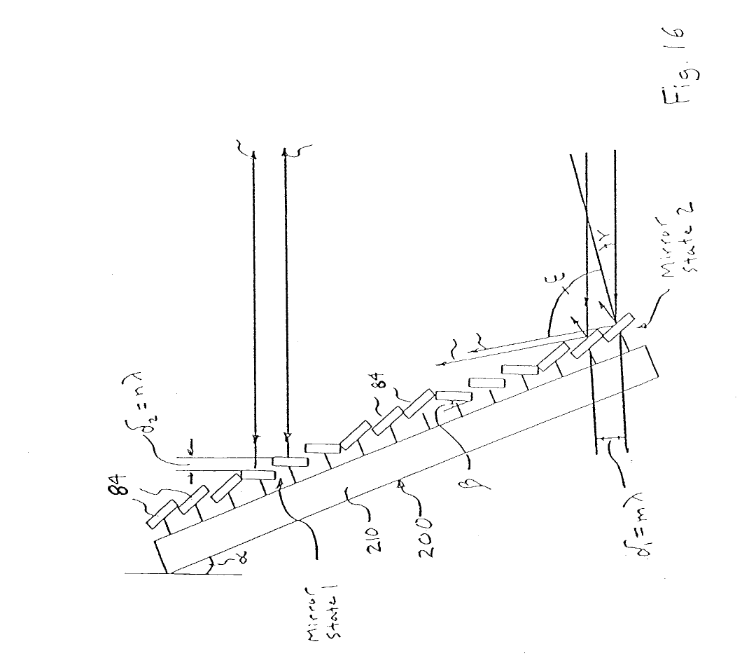

FIG. 13 illustrates a pair of micro-mirrors 84 of a micromirror device 200 manufactured by Texas Instruments, namely a digital micro-mirror device (DMD™). The micromirror device 200 is monolithically fabricated by CMOS-like processes over a CMOS memory 202. Each micro-mirror 84 includes an aluminum mirror 204, 16 μm square, that can reflect light in one of two directions, depending on the state of the underlying memory cell 202. Rotation, flipping or tilting of the mirror 204 is accomplished through electrostatic attraction produced by voltage differences between the mirror and the underlying memory cell. With the memory cell 202 in the on (1) state, the mirror 204 rotates or tilts approximately +10 degrees. With the memory cell in the off (0) state, the mirror tilts approximately −10 degrees. As shown in FIG. 14, the micro-mirrors 84 flip about an axis 205.

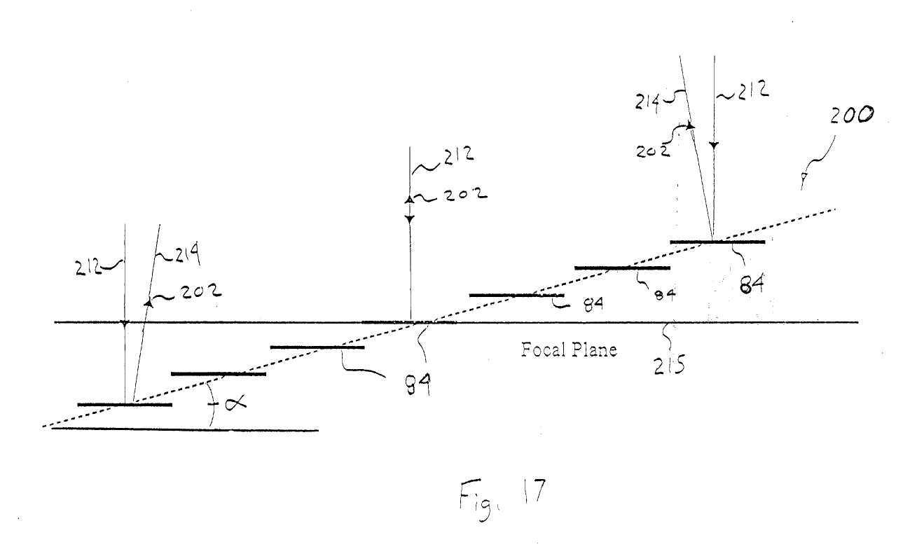

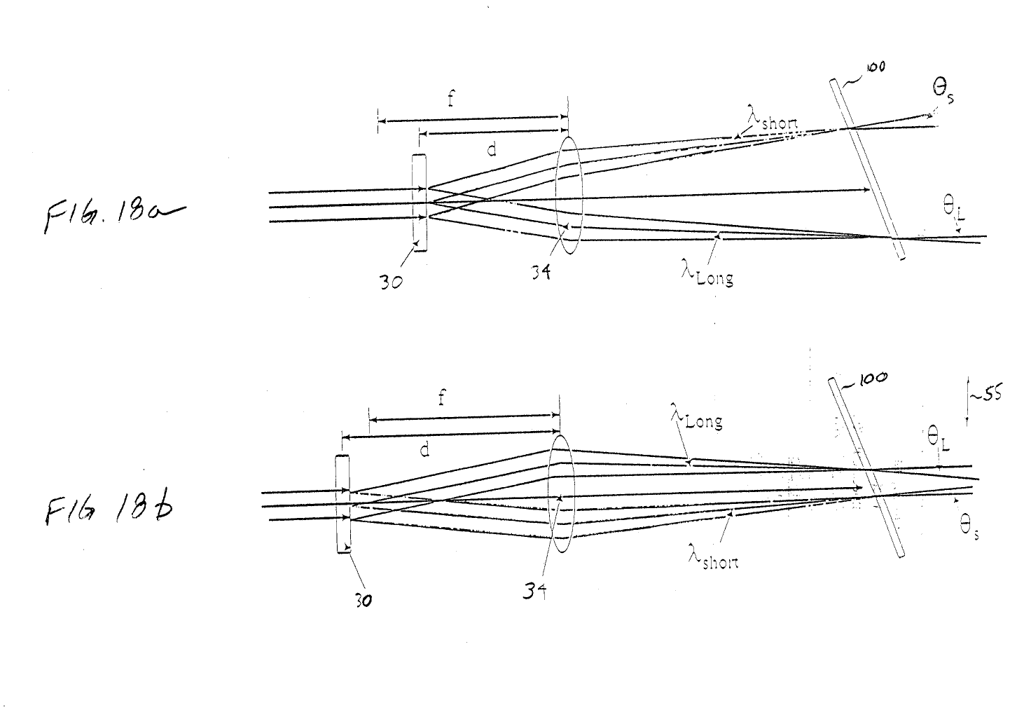

FIGS. 15a and 15b illustrate the orientation of a micro-mirror device 200 similar to that shown in FIG. 13, wherein neither the first or second position (i.e., on or off state) of the micro-mirrors 84 is parallel to the base or substrate 210 of the micromirror device 200, as shown in FIGS. 4a and 4b. Consequently as shown in FIG. 15a, the base 210 of the micro-mirror device 200 is mounted at a non-orthogonal angle α relative to the collimated light 83 to position the micro-mirrors 84, which are disposed at the first position, perpendicular to the collimated light 44, so that the light reflected off the micro-mirrors in the first position reflect substantially back through the return path, as indicated by arrows 94, to provide the output signal 48 at optical fiber 50. Consequently, the tilt angle of the mirror between the horizontal position and the first position (e.g., 10 degrees) is approximately equal to the angle α of the micro-mirror device. FIG. 15b is illustrative of the micro-mirror device 200 when the micro-mirrors 84 are disposed in the second position to drop an input channel 14 to the output signal 48 at optical fiber 50.

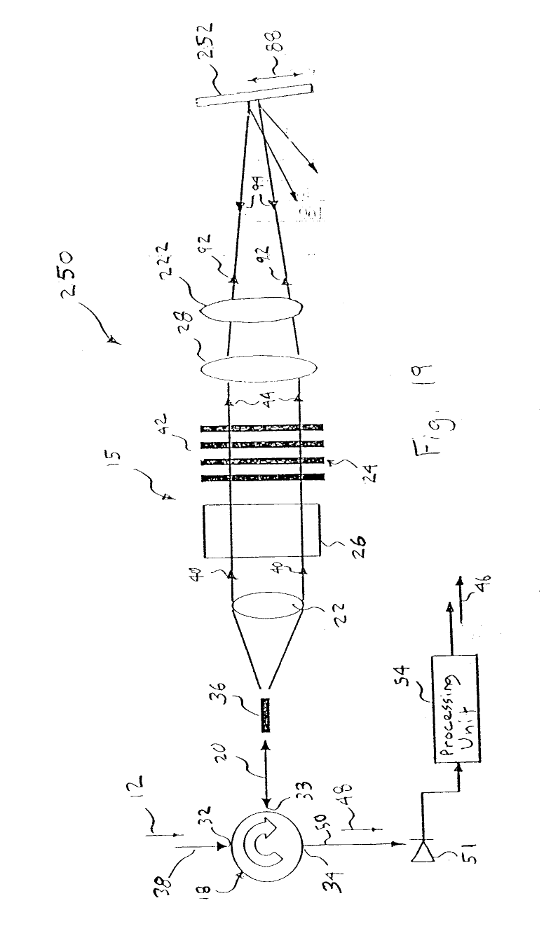

In using the micro-mirror array device 200, it is important that the reflection from each micro-mirror 84 adds coherently in the far field, so the angle α to which the micro-mirror device 200 is tilted has a very strong influence on the overall efficiency of the device. FIG. 16 illustrates the phase condition of the micro-mirrors in both states (i.e., State 1, State 2) for efficient reflection in either condition.

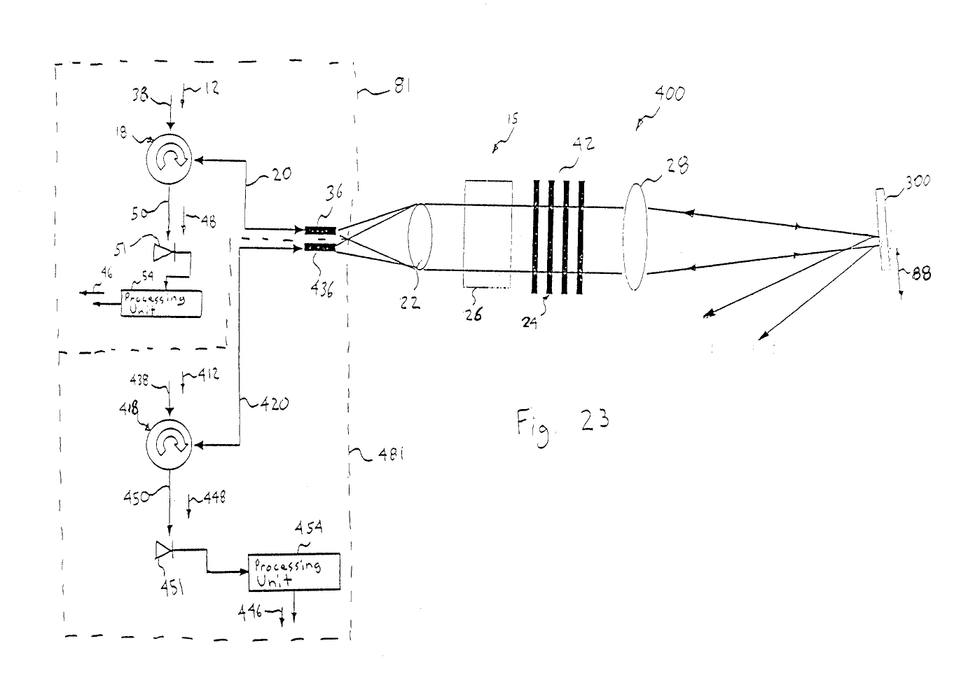

In an exemplary embodiment of the micro-mirror device 200 in FIG. 16, the effective pixel pitch ρ is about 19.4 μm (see FIG. 20), so for a mirror tilt angle β of 9.2 degrees, the array is effectively blazed for Littrow operation in the n=+2 order for the position indicated as Mirror State 1 in FIG. 16 (i.e., first position). For Mirror State 2, the incident angle γ on the micro-mirror device 200 is now 9.2 degrees and the exit angle ε from the array is 27.6 degrees. Using these numbers, the micro-mirror device is nearly blazed for fourth-order for mirrors in Mirror State 2.

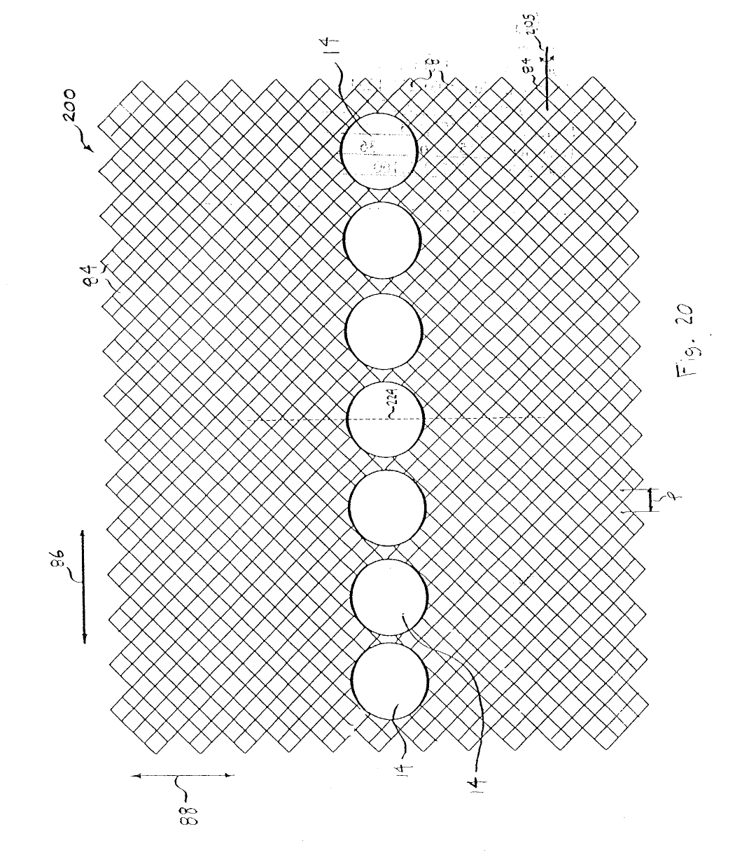

FIG. 17 graphically illustrates the micro-mirror device 200 wherein the micro-mirrors 84 are disposed in the retro-reflective operation (i.e., first position), such that the incident light reflects back along the return path, as indicated by arrows 202. For retro-reflective operation, the micro-mirror device 200 acts as a blazed grating held in a “Littrow” configuration, as shown in FIG. 1, with the blaze angle equal to the mirror tilt “α” (e.g., 10 degrees). The grating equation provides a relationship between the light beam angle of incidence, θᵢ; angle of reflection, θₘ; the pitch of the micro-mirror array; the mirror tilt; and the wavelength of the incident light. Because the wavelength varies across the micro-mirror array for parallel input beams, the angle of reflection of the beams varies across the apparatus. Introducing the micro-mirror device 200 at the focal plane 215 implements the critical device feature of providing separately addressable groups of mirrors to reflect different wavelength components of the beam. Because of the above reflection characteristics of the micro-mirror device 200, the beam is reflected as from a curved concave mirror surface, as shown in FIG. 18 with the micro-mirror device 200 in the focal plane 215. Consequently, when the micro-mirror device is oriented to retro-reflect at a wavelength hitting near the mirror center, wavelengths disposed away from the center are reflected toward the beam center as if the beam were reflected from a curved concave mirror. In other words, the micro-mirror device 200 reflects the incident light 212 reflecting off the central portion of the array of micro-mirrors directly back along the incident angle of the light, while the incident light 212 reflecting off the micro-mirrors disposed further away from the central portion of the array progressively direct the light inward at increasing angles of reflection, as indicated by 214.

FIGS. 18a and 18b illustrate a technique to compensate for this diffraction effect introduced by the micromirror array, described hereinbefore.

FIG. 18a illustrates the case where a grating order causes the shorter wavelength light to hit a part of the micromirror array 100 that is closer than the section illuminated by the longer wavelengths. In this case the Fourier lens 34 is placed at a distance “d” from the grating 30 that is shorter than focal length “f” of the Fourier lens. For example, the distance “d” may be approximately 71 mm and the focal length may be approximately 82 mm. It may be advantageous to use this configuration if package size is limited, as this configuration minimizes the overall length of the optical train.

FIG. 18b illustrates the case where the grating order causes the longer wavelengths to hit a part of the micromirror array 100 that is closer than the section illuminated by the shorter wavelengths. In this case the Fourier lens is placed a distance “d” from the grating 30 that is longer than focal length “f” of the Fourier lens 34. This configuration may be advantageous to minimize the overall area illuminated by the dispersed spectrum on the micromirror array.

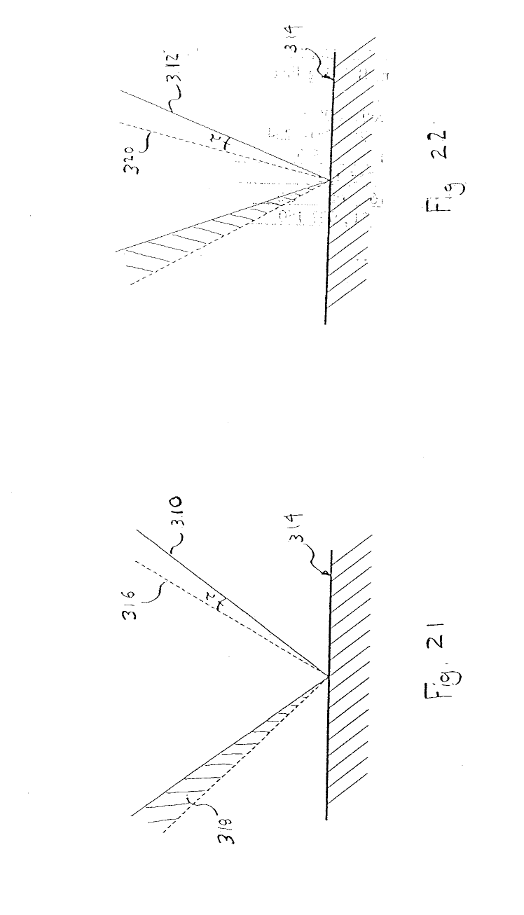

Alternatively, the effective curvature of the micro-mirror device 200 may be compensated for using a “field correction” lens 222. In an exemplary embodiment shown in FIG. 19, the OCM 250 is similar to the OCM 10 of FIG. 1, and therefore similar components have the same reference numeral. The OCM 250 includes a field correction lens 222 disposed optically between the bulk lens 28 and the spatial light modulator 252, which includes micro-mirror device 200. The “field correction” lens 222 respectively compensate for the optical channels reflecting off the spatial light modulator 252.

As described hereinbefore, the micro-mirrors 84 of the micro-mirror device 200 flip about a diagonal axis 205 as shown in FIGS. 14 and 20. In an exemplary embodiment of the present invention shown in FIG. 20, the optical input channels 14 are focused on the micro-mirror device 200 such that the spectral axis 86 of the optical channels 14 is parallel to the tilt axis 205 of the micro-mirrors. This configuration is achieved by rotating the micro-mirror device 45 degrees compared to the configuration shown in FIG. 3. Alternatively, the optical channels 14 may be focused such that the spectral axis 86 of the channels are perpendicular to tilt axis 205 of the micro-mirrors similar to that shown in FIGS. 10 and 11. Further, one will appreciate that the orientation of the tilt axis 205 and the spectral axis 86 may be at any angle.

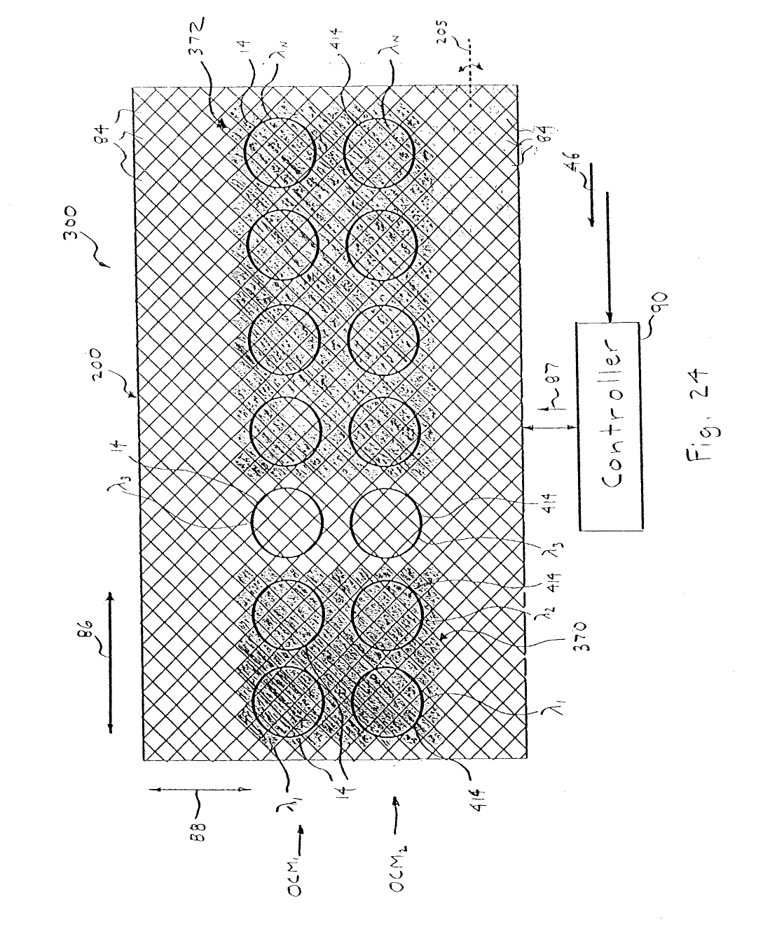

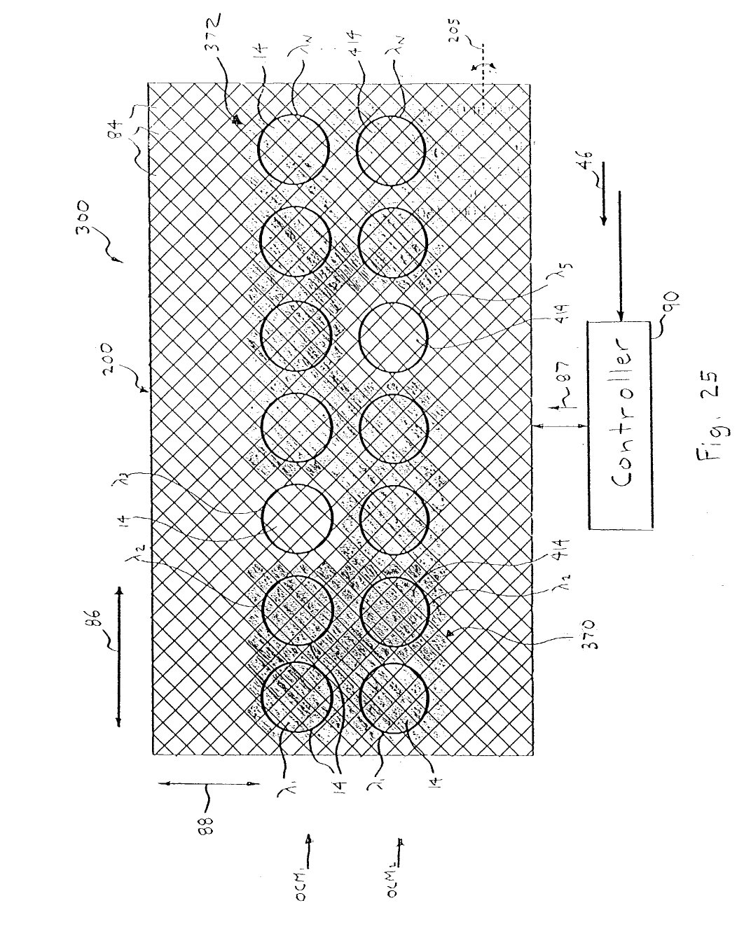

In the operation of the micro-mirror device 200 manufactured by Texas Instruments, described hereinbefore, all the micro-mirrors 84 of the device 200 releases when any of the micro-mirrors are flipped from one position to the other. In other words, each of the mirrors will momentarily tilt towards the horizontal position upon a position change of any of the micro-mirrors. Consequently, this momentary tilt of the micro-mirrors 84 creates a ringing or flicker in the light reflecting off the micro-mirrors. To reduce or eliminate the effect of the ringing of the light during the transition of the micro-mirrors 84, the light is focused tightly on the micro-mirror device 200. FIGS. 21 and 22 illustrate the effect of the ringing of micro-mirrors during their transition. Both FIGS. 21 and 22 show an incident light beam 310, 312, respectively, reflecting off a mirror surface at different focal lengths. The light beam 310 of FIG. 22 has a relatively short focal length, and therefore has a relatively wide beam width. When the micro-mirror surface 314 momentarily tilts or rings a predetermined angle τ, the reflected beam 316, shown in dashed lines, reflects off the mirror surface at the angle τ. The shaded portion 318 is illustrative of the lost light due to the momentary ringing, which represents a relatively small portion of the incident light 310. In contrast, the light beam 312 of FIG. 22 has a relatively long focal length, and therefore has a relatively narrow beam width. When the micro-mirror surface 314 momentarily tilts or rings a predetermined angle τ, the reflected beam 320, shown in dashed lines, reflects off the mirror surface at the angle τ. The shaded portion 322 is illustrative of the lost light due to the momentary ringing, which represents a greater portion of the incident light 312, than the lost light of the incident light of FIG. 21. Consequently, the sensitivity of the momentary tilt of the micro-mirrors is minimized by tightly focusing the optical channels on the micro-mirror device 200. Advantageously, tightly focusing of the optical channels also reduces the tilt sensitivity of the micro-mirror device due to other factors, such as thermal changes, shock and vibration.

While the embodiments of the present invention described hereinabove illustrate a single OCM using a set of optical components, it would be advantageous to provide an embodiment including a plurality of OCMs that uses a substantial number of common optical components, including the spatial light modulator.

FIG. 23 illustrates such an embodiment of an OCM 400, which is substantially the same as the OCM 10 in FIG. 1 having a spatial light modulator 300 including a micro-mirror device 22 of FIG. 20. Common components between the embodiments have the same reference numerals. The OCM 400 provides a pair of OCMs (i.e., OCM₁, OCM₂), each of which use substantially all the same optical components, namely the collimating lens 22, the mirror 26, the diffraction grating 24, the bulk lens 28 and the spatial light modulator 300. The first OCM (OCM₁) is substantially the same as the OCM 10 of FIG. 11. The second OCM (OCM₂) is provided by adding a complementary set of input optical components 481. The input optical components 81 of OCM₁ and the input optical components 481 of OCM₂ have the same last two numerals, and therefore the input optical components 481 of OCM₂ are the same as those of the similar components 81 of the OCM₁.

To provide a plurality of OCMs (OCM₁, OCM₂) using similar components, each OCM uses a different portion of the micro-mirror device 200, as shown in FIG. 24, which is accomplished by displacing the ends 36,436 of the pigtails 20,420 of the OCMs. As shown, the input channels of each OCM are spaced in the spatial axis 88 a predetermined distance on the micro-mirror device 200, as shown in FIG. 24. Similar to that described hereinabove, the groups of micro-mirrors 370,372 of shaded micro-mirrors 84 drop the optical channels at λ₁, λ₂ and λ₄-λ_{N} of both OCMs (OCM₁,OCM₂), and reflect the selected input channels at λ₃ back to each respective input pigtail 20,420. One will recognize that while the same optical channels are selected (at λ₃, for example) in the embodiment shown in FIG. 24, the micro-mirrors 84 may be tilted to individually select different optical input channels 14,414 (at λ₃ and λ₅, for example), as shown in FIG. 25.

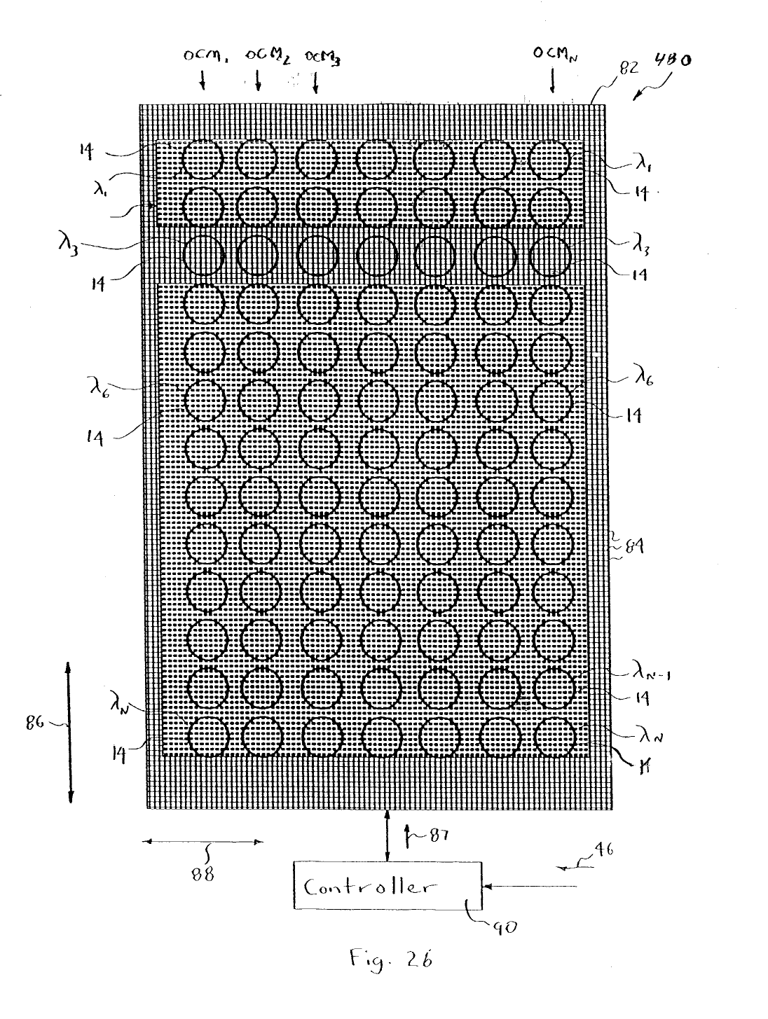

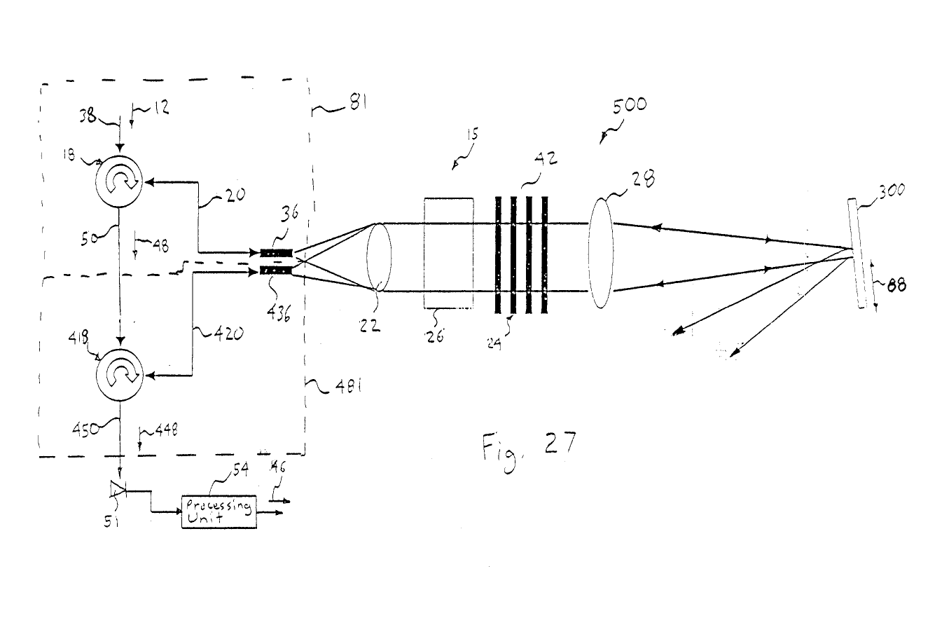

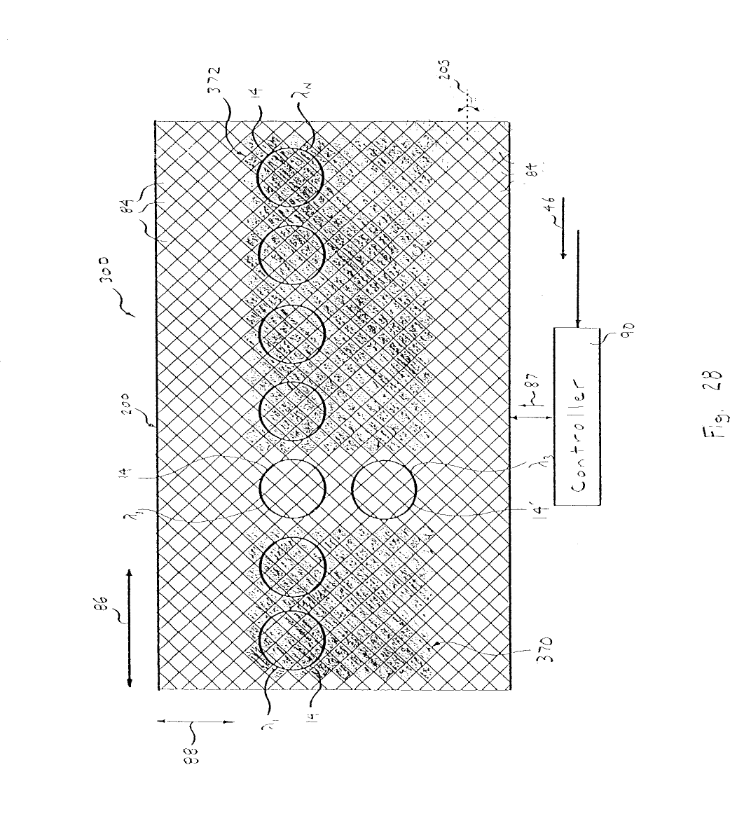

FIG. 26 illustrates the micro-mirror device 480 of another embodiment of the present invention similar to that shown in FIGS. 23 and 24, wherein the embodiment has N number of OCMs (OCM₁-OCM_{N}). The embodiment includes N number of complementary input optical components 81,481 (see FIG. 22) that provide respective input signals to the set of common optical components 20,22,24,26,28,480. The embodiment functions substantially the same as the OCM 400 of FIG. 23, as described hereinbefore.

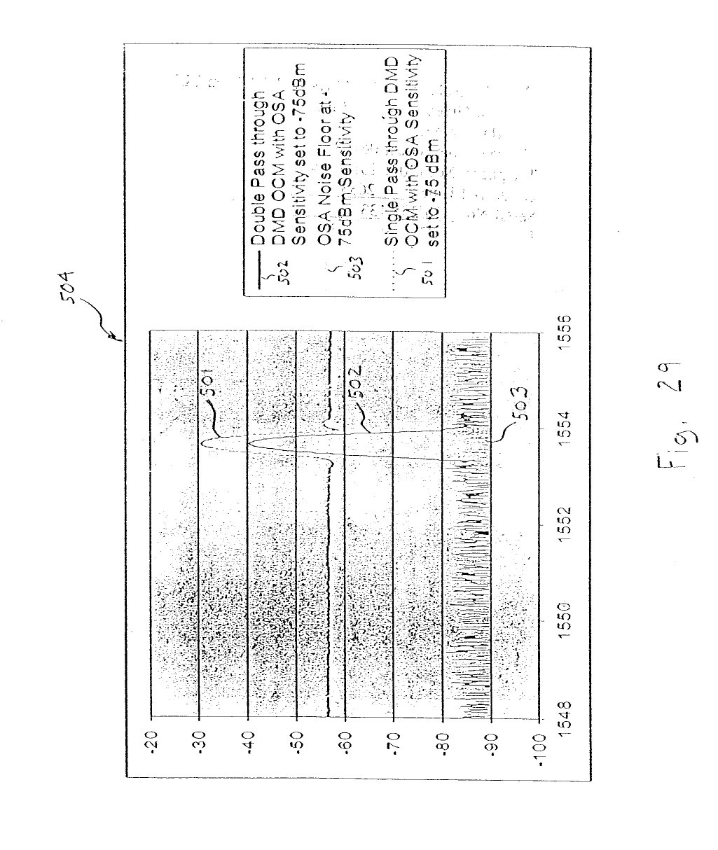

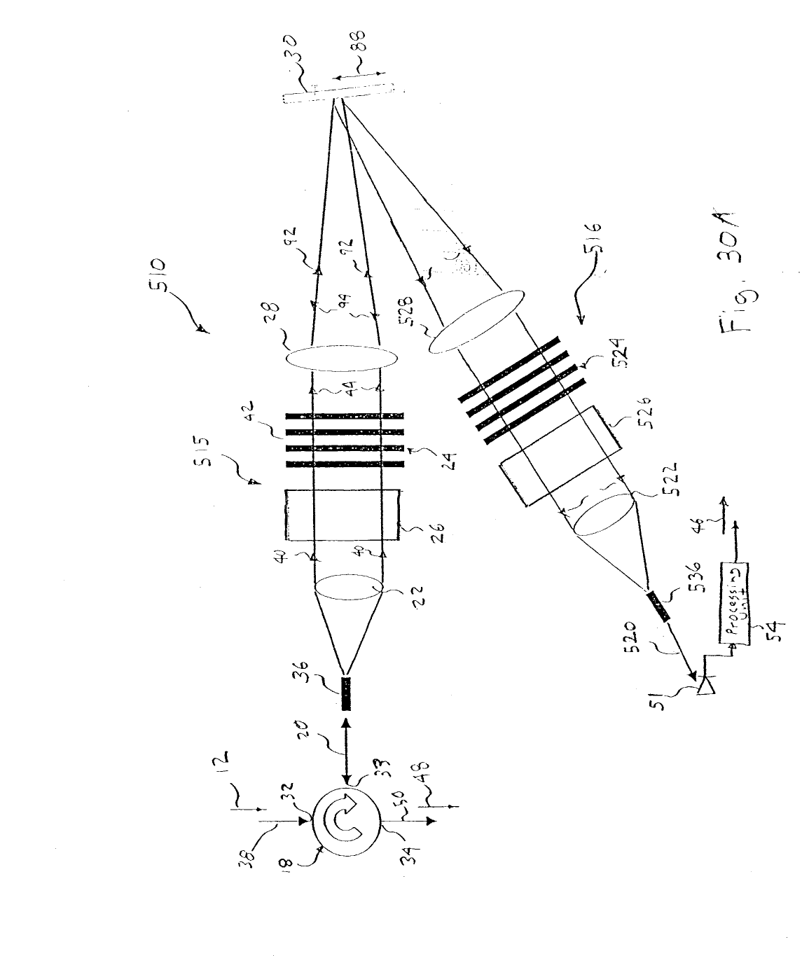

A further embodiment of the present invention includes a dual pass or double bounce OCM 500, as shown in FIGS. 27 and 28. The dual pass OCM 500 is substantially similar to the dual OCM 400 shown in FIG. 23, and therefore common components have the same reference numeral. Functionally, the dual pass OCM 500 reflects the selected optical input channel off the spatial light modulator 300 and through the optics 22,24,26,28 twice. The multiplicative properties of the double pass technique provide a very narrow filter function having steep sides and greater isolation between filter functions, as illustrated in FIG. 29. FIG. 29 shows a plot 504 of filter function 501 of a single pass OCM (e.g., OCM 400), the filter function 502 of a dual pass OCM (e.g., OCM 500), and the noise level 503.

The ability to control the tilt patterns of the micro-mirror device enables the shape (e.g., narrowness) and center wavelength to be statically or dynamically modified, which is similar to that disclosed in U.S. patent application Ser. Nos. 09/648,525 (Cidra's docket no. CC-0273) and 09/751,589 (Cidra's docket no. CC-0274A), which are incorporated herein by reference.

Referring to FIGS. 27 and 28 in the operation of the OCM 500, the input signal 12 is first dispersed by the diffraction grating 24 onto the micro-mirror device 200. Each input channel 14 is spread along the spectral axis 86 as shown in FIG. 28. Similar to that described hereinabove, the groups of micro-mirrors 370,372 of shaded micro-mirrors 84 drop the optical input channels at λ₁, λ₂ and λ₄-λ_{N} of the input signal 12, and reflect the selected input channel at λ₃ back to the first pigtail 20. The selected input channel at λ₃ then propagates to second pigtail 420 through the first and second circulators 20,420 respectively. The end 436 of the second pigtail 420 is displaced such that the selected input channel 14′ at λ₃ is dispersed onto the micro-mirror device 200 and spaced in the spatial axis 88 a predetermined distance from the input channel 14 at λ₃, as shown in FIG. 28. The micro-mirrors 84 are titled to reflect the selected input channel 14′ back to second pigtail 420, while the micro-mirrors adjacent the input channels at λ₁, λ₂ and λ₄-λ_{N} are tilted to drop any remaining light. The selected input channel 14′ then propagates through the second circulator 418 to the photodiode 51, which provides a signal to the processing unit 54.

While the micro-mirror patterns that reflect the desired input channel 14 and the selected input channel 14′ are shown to be the same, one will recognize that the patterns may be different such that the each pattern reflects a different portion of the desired input channel 14 and the selected input channel 14′, which results in a different overall OCM filter function.

The OCMs 10,110 may be selectively configured or modified for any wavelength plan by simply modifying the software. For example, an OCM for selecting and detecting a 50 Ghz WDM optical signal may be modified to select and detect a 100 Ghz or 25 Ghz WDM optical signal by simply modifying or downloading a different switching algorithm, without modifying the hardware. In other words, any changes to the WDM signal structure (such as variances in the spacing of the channels, the shapes of the light beams, and/or the center wavelength of the light beams) may be accommodated with the OCM by simply changing statically or dynamically the switching algorithm (e.g., modifying the bit map). For example, the software can be modified or written to provide a first pattern of micro-mirrors 84 having a predetermined width that reflects a selected 50 Ghz optical channel 14 back to the photodetector 51, and/or provide a second pattern of micro-mirrors 84 having a predetermined width that reflects a selected 100 Ghz optical channel back to the photodetector 51, wherein the width of the first pattern is greater than the width of the second pattern.

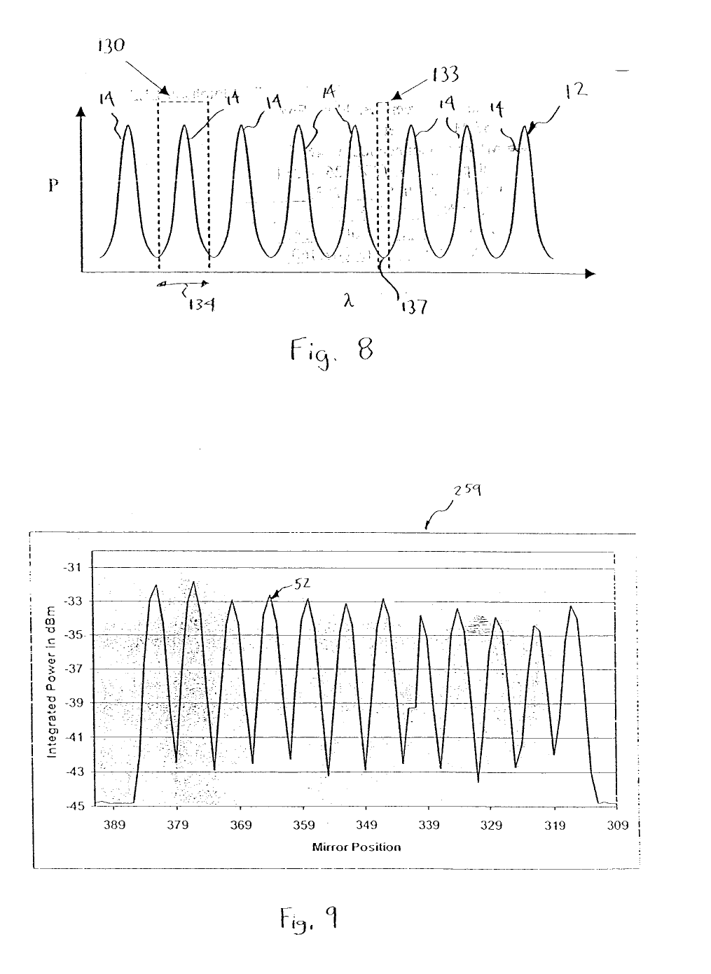

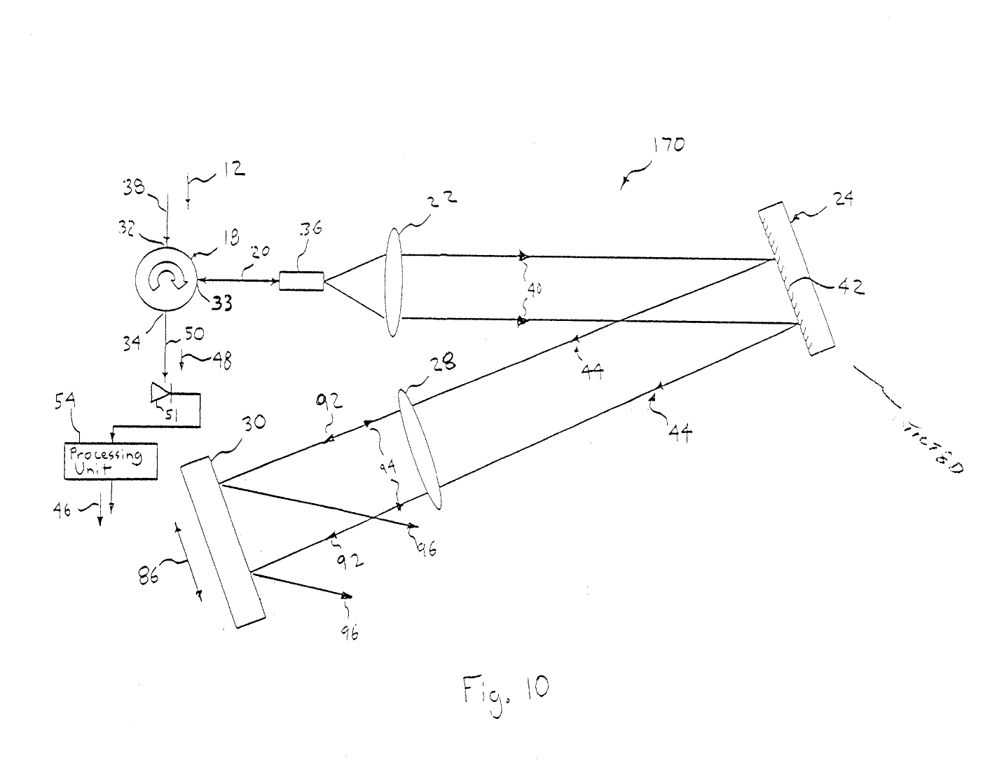

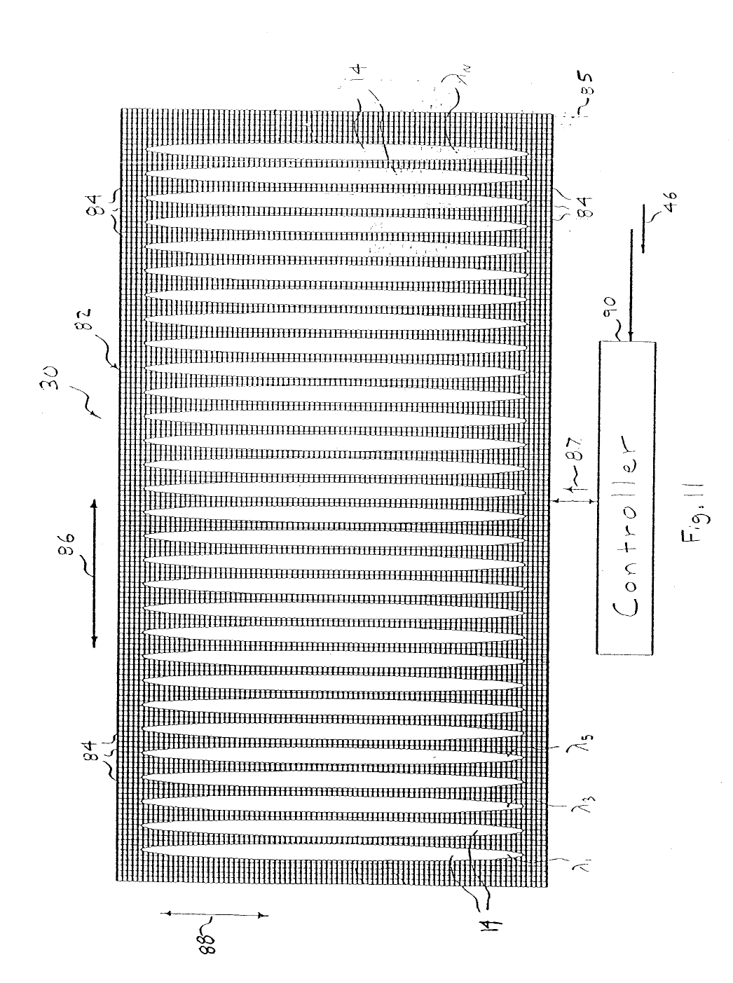

Further, the programmability of the spatial light modulator 300 enables the OCMs of the present invention (e.g., OCMs 10,110,500) to be configured to function as an optical channel analyzer (OCA) by modifying the switching algorithm, as described hereinbefore, to dynamically vary the pattern of micro-mirrors 84 to sense desired portions of the input signal 12. For example, the width (in the spectral axis 86) of the pattern of micro-mirrors may be varied to be sufficiently wide to measure the power of each of the optical channels (as shown in FIG. 8 at 130), and sufficiently narrow to measure the noise level 137 between the optical channels 14. The processing unit 54 can then process this data to determine additional parameters of the input signal that an OCM 10,110,500 is incapable of determining, such as the optical signal-to-noise ratio (OSNR) of the each input signal.

The plot of FIG. 8 illustrates an exemplary input signal 12, and a representative wide filter function 130 to measure the power of an optical channel 14 and a representative narrow filter function 133 to measure the noise level between the optical channels 137, shown in dashed lines. The width 134 of the filter function 130 is substantially the width of the optical channels 14 to output substantially the entire channel from which the power can be determined. The width of the filter function 133 is sufficiently narrow to enable the measurement of the noise level 137 between input channels 14.

In one embodiment of an OCA, the processing unit 54 and/or controller 90 may sequentially flip the micro-mirrors 84 to first measure the power of each of the input channels 14 using the wider filter function 130, and then measure the noise level 137 between each input channel 14 using the narrower filter function 133. Alternatively, the processing unit 54 and/or controller 90 may sequentially measure the power and noise level over the spectrum of the input signal by alternately changing the width of the pattern of micro-mirrors 84 to sequentially measure the power and noise level of each consecutive input channel 14, such that the noise and power measurements are determined in a single scan of the spectrum.

While the operation of an OCA described hereinbefore changes the width of the filter function (or width of the micro-mirror pattern) to measure the power and noise level of each input channel 14, one will recognize that a narrow filter function may be used to measure both power and noise level in a single scan of the spectrum. This method, however, may required additional computation and knowledge of the characteristics of the input channels 14 to provide a more accurate power measurement. Further, the OCM/OCA of the present invention contemplates that te width of the filter function may be dynamically changed to any device width and that any desired filter function may be scanned over any desired spectrum.

FIG. 9 shows output data 259 of an OCA similar to the OCM 10 of FIG. 1 having a micro-mirror device 200 similar to that shown in FIG. 13, which is described in greater detail hereinafter. A plurality of laser sources, which are centered on the ITU grid, are provided at the input fiber 38 to simulate the input channels 14 of a WDM input signal 12. In the operation of the OCA, the switching algorithm flips sequentially a pattern of micro-mirrors 84 that reflect the selected light to the photodetector 51 along the spectrum. The width of the pattern is less than the width of the input channelized ITU grid. FIG. 19 shows the output signal 52 from the photodetector 51 as the narrow pattern of the micro-mirrors are tilted to reflect back sequentially each successive portion of the input signal 12.

The ability of the OCA to measure the peak of the input channels enables the OCA to also determine the center wavelength of the input channels. Consequently, the OCA can monitor and compensate for any changes or drift (mechanical or thermal) of the OCA by comparing the measured center wavelength of a single or plurality of input channels with the known center wavelength of the input channel(s). In response to this feedback, the switching algorithm may modify or shift the micro-mirror pattern(s) to compensate for any deviation or drift.

In another embodiment, the OCA may include a laser source or other signal generating source (not shown) to provide a reference signal having a known center wavelength or outer wavelength pattern. The reference signal is provided to and sensed by the OCA to determine any changes or drift (mechanical or thermal) of the OCA by comparing the measured center wavelength of the reference signal with the known center wavelength of the laser source. In response to this feedback, the switching algorithm may modify or shift the micro-mirror pattern(s) to compensate for any deviation or drift.

The reference signal may be provided or sensed by the OCA in a number of methods. For example, the OCA may periodically switch between the input signal 12 and the reference signal via an optical switch. Alternatively, the reference signal may be provided at another input pigtail and simultaneously projected onto the spatial light modulator 300 spaced in the spatial axis, effectively functioning as a dual OCA similar to that shown in FIG. 23. Another example includes adding the reference signal to the input signal 12, using an optical coupler (not shown), wherein the center wavelength of the reference signal is outside the used spectrum of the input signal 12 (e.g., “C” band).

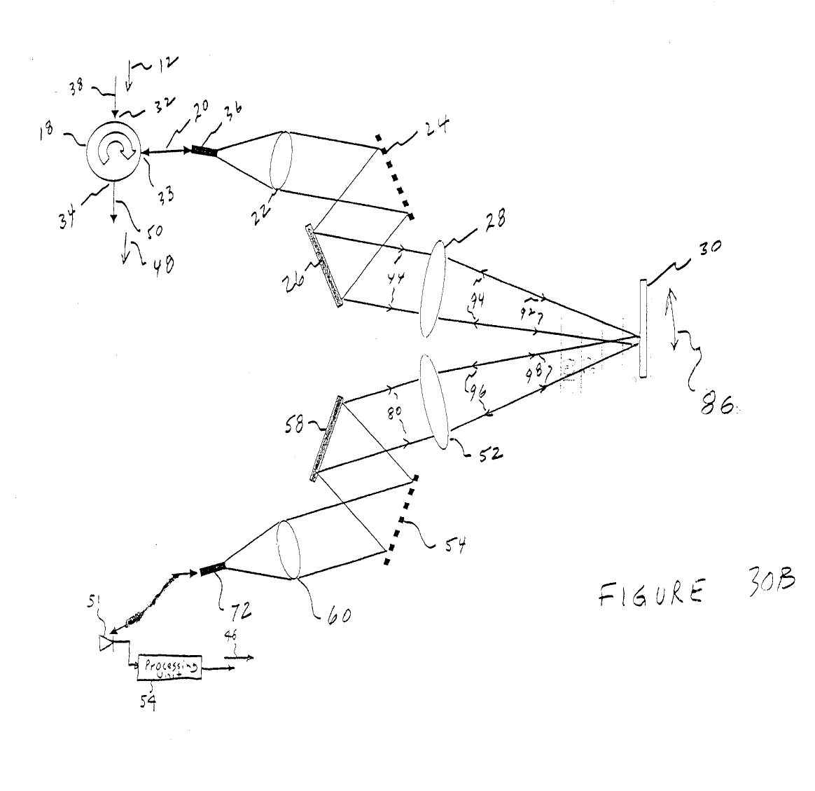

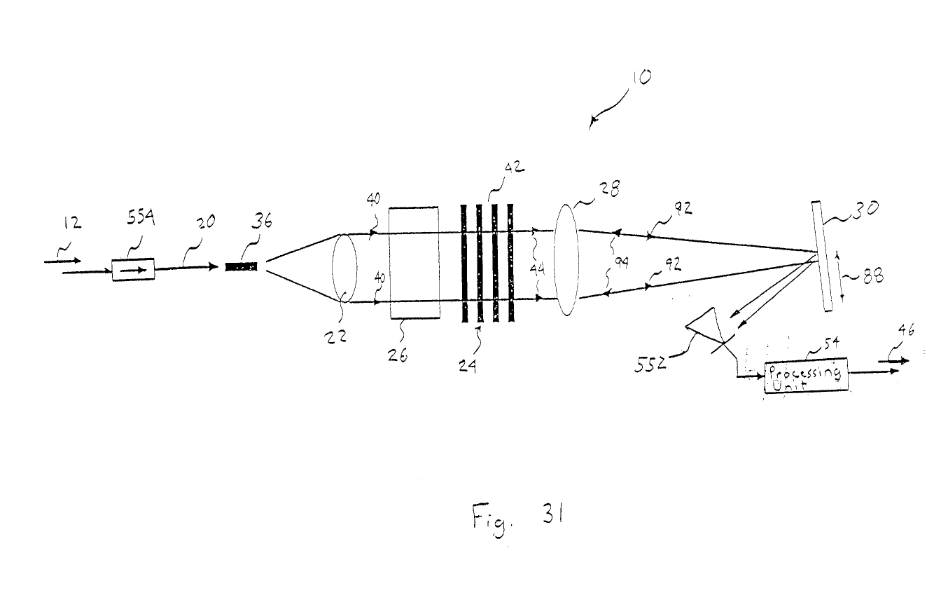

Another embodiment of an OCM 510 is shown in FIG. 30A, which is similar to the OCM 10 of FIG. 1A. The OCM 510 includes a pair of similar optical portions 515,516 for providing respective optical input channels 14 to and receiving the input channels from the spatial light modulator 30. The optical components 520,522,524,526,528,536 of the optical portion 516 are substantially similar to the complementary optical components 20,22,24,26,28,36 of the first optical portion 515.

In the operation of the OCM 510, the micro-mirrors 84 of the spatial light modulator are tilted to reflect all the input channels 14 of the input signal 12, except for the selected optical signal to be sensed, back along the return path 94 to provide the output signal 48 at optical fiber 50. The micromirrors 84 of the spatial light modulator 30 reflect the selected optical signal through the second optical portion 516 to the photodetector 51 and processing unit 54 to sense and determine the desired optical parameter of the selected optical signal.

FIG. 30B shows an alternative embodiment to that shown in FIG. 30A, wherein the DMD device 30 is oriented so that the mirrors 84 pivot or tilt on an axis 85 that is perpendicular to the spectral axis 86. (As shown, the tilt axis 85 runs into and out of FIG. 30B.) This embodiment is particularly important when implementing the chisel prism arrangement discussed below in relation to FIGS. 30A, 31, 32. Similar elements in FIGS. 30A and 30B are labelled with similar reference numerals.

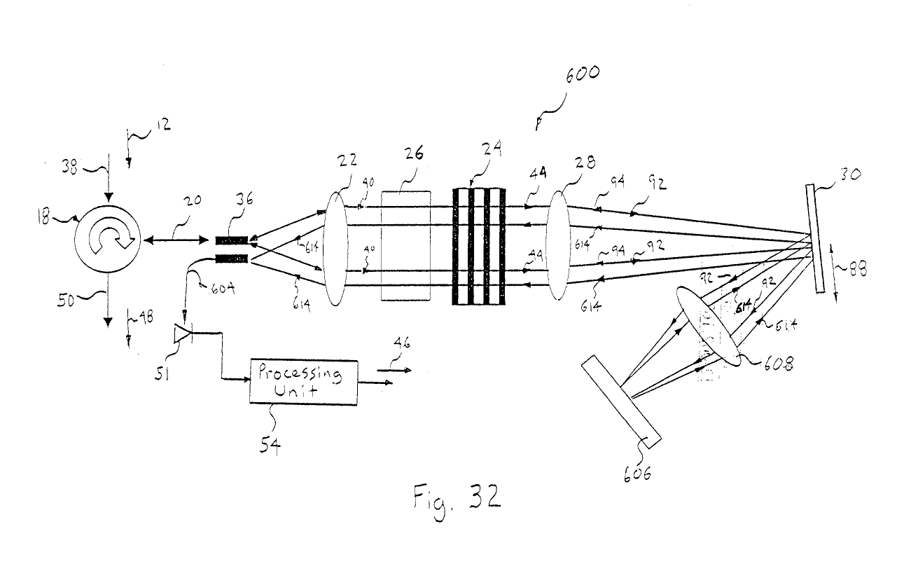

Another embodiment of an OCM 550 is shown in FIG. 31, which is similar to the OCM 510 of FIG. 30. Similar components of the OCMs 510, 550 have the same reference numeral. The OCM 510 replaces the second optical portion 516 with a large area detector 552, such as a photodiode, that directly receives the selected input channel reflecting off the spatial light modulator. As described hereinbefore, the detector 552 provides a sensed signal 52, indicative of a parameter of the selected optical channel (e.g., channel power) to a processing unit 54, which interfaces with an external device(s) 56. Further, the first circulator 18 of FIG. 30 has been replaced by an isolator 554, which only permits light passing therethrough in the direction of the arrow.

Referring to FIG. 32, another exemplary embodiment of an OCM 600 is shown that is similar to the OCM 510 of FIG. 30, and therefore, similar components have the same reference numerals. The OCM 600 directs the optical input signal 12 and selected input signal 602 through a set of common optical components. The optical components are disposed in two tiers or horizontal planes similar to the embodiments discussed hereinbefore. Specifically, the three-port circulator 18, the pigtails 20,604, the collimator 22 and the diffraction grating 24 are disposed in a first tier or horizontal plane. The mirror 26, the bulk lens 28 and the spatial light modulator 30 are disposed in the second tier or horizontal plane. Further, the mirror 606 and the lens 608 are disposed in the second tier.

The circulator 18 directs the input signal 12 from the optical fiber 38 to the first pigtail 20. The input signal 12 exits the first pigtail (into free space) and passes through the collimator 22, which collimates the input signal. The collimated input signal 40 is incident on the diffraction grating 24, which separates spatially the optical input channels 14 of the collimated input signal 40 by diffracting or dispersing the light from the diffraction grating. The diffraction grating 24 directs the separated light 44 to the mirror 26 disposed in the second tier. The mirror 26 reflects the separated light 44 to the bulk lens 28 (e.g., a Fourier lens), which focuses the separated light onto the micro-mirror device 82 of the spatial light modulator 30, as shown in FIG. 2. In response to a switching algorithm and input command 46, the spatial light modulator 300 selectively reflects a selected input signal through the lens 608 to the mirror 606, or back through common optical components to pigtail 20.

In the operation of the OCM 600, the micro-mirrors 84 of the spatial light modulator 30 are tilted to a first position to reflect all the input channels 14 of the input signal 12, except for the selected optical signal to be sensed, back along the return path 94 to provide the output signal 48 at optical fiber 50. The micro-mirrors 84 of the spatial light modulator 30 are tilted to a second position to reflect the selected input signal through the lens 608 to the mirror 606. The mirror 606 is tilted such that the selected input signal is reflected along a slightly different path, as indicated by arrows 612 than the return path 94. The selected input channel propagates to the second pigtail 604, as indicated by arrows 614, to the photodetector 51 and processing unit 54 to sense and determine the desired optical parameter of the selected optical signal.

One will recognize that the circulators 18 of OCMs 510, 550, 600 of FIGS. 30-32, respectively, may be substituted for an optical isolator to attenuate or block the optical channels reflected back to the first pigtail 20.

While the OCMs 510, 600 described hereinbefore redirect all the light of the selected input channel to the photodetector 51, the array of micro-mirrors of the spatial light modulator may be selectively tilted to redirect a portion of the selected input channel to the photodetector 51 and reflecting the remaining portion of the selected input channel back to the fiber 50. Effectively, the OCM 510 taps a selectable portion of the desired input channel 14 while reflecting the other input channels 14 and remaining portion of the selected input channel back to the output fiber 50.

One will appreciate that each portion or pixel of light reflects the optical channel by a percentage defined by the number of micro-mirrors 84 illuminated by the optical input channel. For example, assuming each optical channel 14 illuminates 300 micro-mirrors, each micro-mirror is representative of approximately 0.3% of light (or approximately 0.02 dB) of the optical signal when the micro-mirror is tilted away. The above example assumes that the intensity of the light of each optical channel is uniform over the entire cross-section of the beam of light. One will appreciate that the intensity from one end to the other end of the beam of the optical channel may be Gaussian in shape, and therefore, the intensity of the pixels of light at the ends of the beams of the optical channels 14 is less than the center portion of the beams, which advantageously increases the resolution of the power of the selected input channel 14, the greater the resolution of the power of the redirected portion of that optical channel.

One skilled in the art will appreciate that a diffraction grating has a predetermined polarization dependence loss (PDL) associated therewith. The PDL of a diffraction grating 24 is dependent on the geometry of the etched grooves 42 of the grating. Consequently, means to mitigate PDL may be desired. One method of mitigating the PDL for any of the embodiments described hereinbefore is to provide a λ/4 plate (not shown) between the spatial light modulator 30 and the diffraction grating 24 (before or after the bulk lens 28). The fast axis of the λ/4 plate is aligned to be approximately 45 degrees to the direction or axis of the lines 42 of the diffraction grating 24. The mirror is angled to reflect the separated channels back through the λ/4 plate to the diffraction grating. In the first pass through the λ/4 plate, the λ/4 plate circularly polarizes the separated light. When the light passes through the λ/4 plate again, the light is linearly polarized to effectively rotate the polarization of the separated channels by 90 degrees. Effectively, the λ/4 plate averages the polarization of the light to reduce or eliminate the PDL. One will appreciate that the λ/4 plate may not be necessary if the diffraction grating has low polarization dependencies, or other PDL compensating techniques are used.

While the micro-mirrors 84 may switch discretely from the first position to the second position, as described hereinabove, the micro-mirrors may move continuously (in an “analog” mode) or in discrete steps between the first position and second position. In the “analog” mode of operation the micro-mirrors can be can be tilted in a continuous range of angles. The ability to control the angle of each individual mirror has the added benefit of much more attenuation resolution than in the digital control case. In the “digital” mode, the number of micro-mirrors 84 illuminated by each channel determines the attenuation step resolution. In the “analog” mode, each mirror can be tilted slightly allowing fully continuous attenuation of the return beam. Alternatively, some combination of micro-mirrors may be switched at a predetermined or selected pulse width modulation to attenuate the optical channel or band.

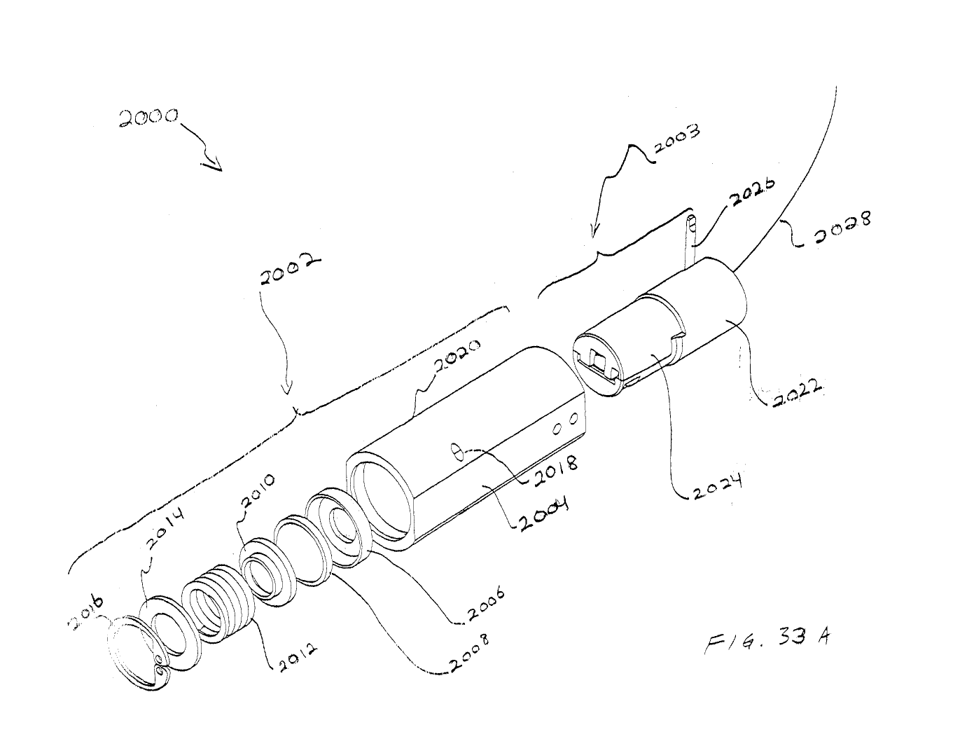

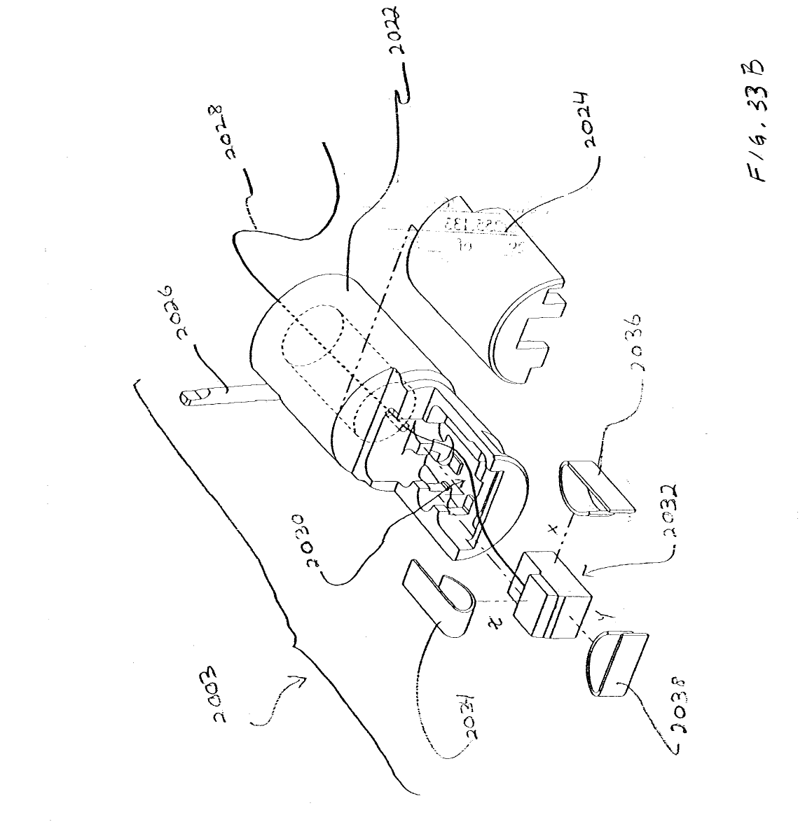

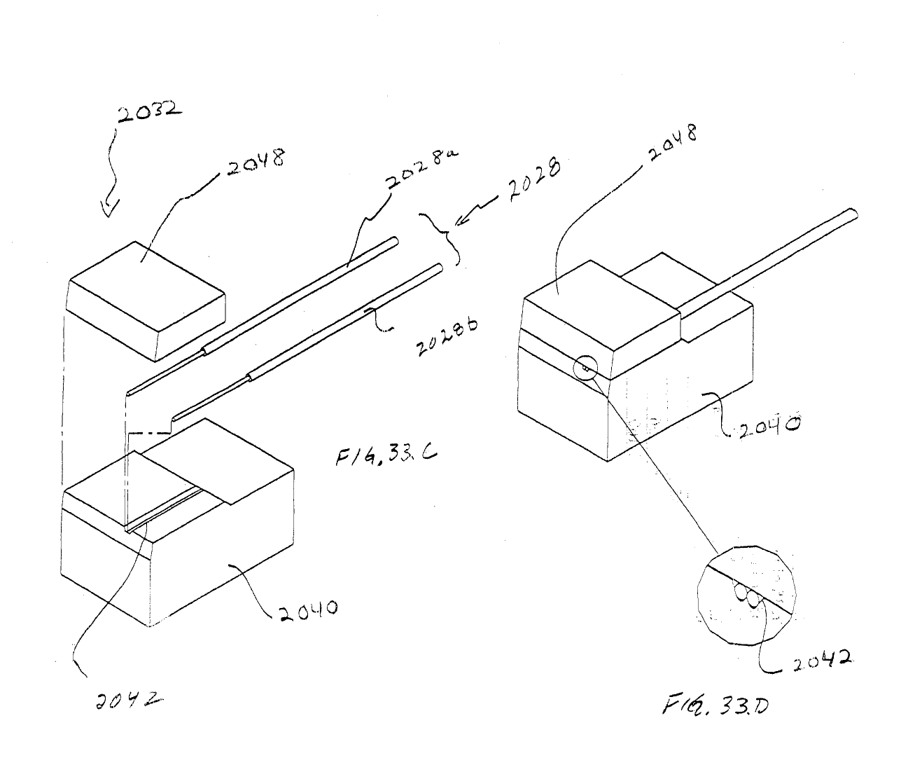

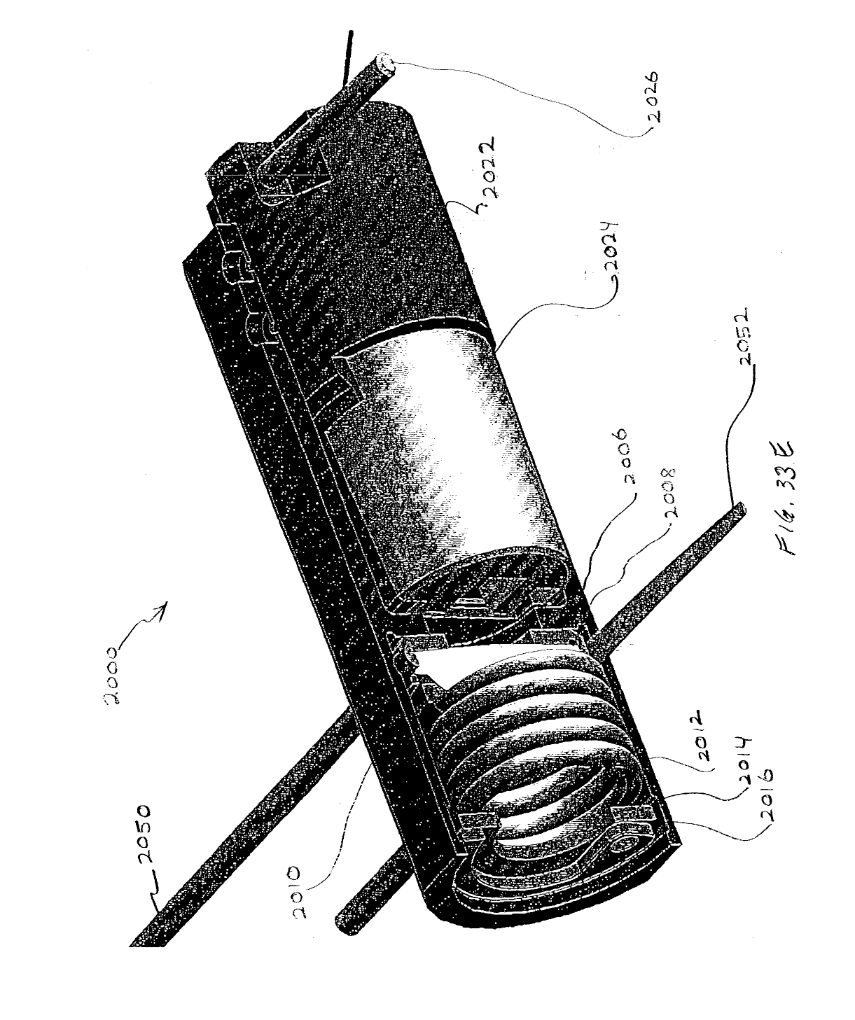

FIG. 33A shows a collimator assembly generally indicated as 2000. The collimator assembly 2000 may be used in place of the arrangement of either the capillary tube 36 and the collimator lens 22, the capillary tube 72 and the collimator lens 60, the capillary tube 636 and the collimator lens 622, the capillary tube 936 and the collimator lens 22, the capillary tube 972 and the collimator lens 60, or any combination thereof, in any one or more of the embodiments described above.

The collimator assembly has a lens subassembly 2002 and a fiber array holder subassembly 2003. The lens subassembly 2002 includes a lens housing 2004 for containing a floating lens cup 2006, a lens 2008, a polymer washer 2010, a spring 2012, a washer 2014 and a C-ring clip 2016. The lens housing 2004 also has two adjustment wedge slots 2018, 2020. The fiber array holder subassembly 2003 includes a fiber V-groove array holder 2022, a subassembly cap 2024 and a clocking pin 2026. The fiber/pigtail 2028 is arranged in the fiber array holder subassembly 2003. The V-groove array holder 2022 is designed to place the one or more fibers 2028 on the nominal origin of an optical/mechanical access. The clocking pin 2026 sets the angle of a semi-kinematic mount, and therefore the angle of the one or more fibers 2028 relative to the nominal optical/mechanical access.

FIG. 33B shows the fiber array holder subassembly 2003 having a fiber V-groove subassembly cavity generally indicated as 2030 for mounting a fiber V-groove subassembly generally indicated as 2032. The fiber V-groove subassembly 2032 is semi-kinematically mounted and maintained in the fiber V-groove subassembly cavity 2030 by three retention springs 2034, 2036, 2038 and the subassembly cap 2024. For example, the mounting of the fiber V-groove subassembly 2032 is characterized as follows: (1) the precision substrate of fiber V-groove array is arranged in the fiber V-groove subassembly cavity 2030; (2) The retention spring 2036 restrains the fiber V-groove subassembly 2032 in the X direction; (3) the two retention springs 2034, 2038 constrain the fiber V-groove subassembly 2032 in the Y and Z directions; and (4) the subassembly cap 2024 is welded to the fiber V-groove array holder 2022 to complete retention of the fiber V-groove subassembly 2032 in a semi-kinematic mount.

FIGS. 32C and D show, by way of example, the fiber V-groove subassembly 2032 having a fiber V-groove subassembly body 2040 having a V-groove 2042 arranged therein for receiving the one or more fibers 2028a, 2028b. The fiber V-groove subassembly 2032 also has a fiber V-groove subassembly cap 2048 for enclosing and holding the fibers 2028a, 2028b in the V-groove 2042, as best shown in FIG. 33D.

FIG. 33E shows a cut-away view of a complete collimator assembly generally indicated as 2000. In the complete collimator assembly 2000, the lens subassembly 2002 is welded to the fiber array holder subassembly 2003. The fully welded collimator assembly 2000 is mounted on a mounting or focusing tool or configuration (not shown) for providing coarse optical/mechanical alignment. Control of the basic mechanics of the mounting configuration is typically in the range of about +/−25 microns and about 0.1°. However, initial and final positioning of other optical components on the mounting configuration require a coarse adjustment of the actual access of the collimator assembly 2000 to match with the optical access of the other components. The coarse adjustment of the collimator optical access is achieved by moving the lens 2008 in the X and Y directions while maintaining a fixed position of the fiber array holder subassembly 2003. Tuning wedges 2050, 2052 are used to move the lens floating cap 2006 in the X and Y directions to provide coarse lens adjustment to about +/−500 microns, as discussed below. However, with use of a piezoelectric impact tool fine displacement with a resolution that is a small fraction of about a micron may be achievable.

The collimator assembly is assembled as follows:

First, the lens subassembly 2002 is assembled. The lens 2008 sits in the floating lens cup 2006. The interfaces between the floating lens cup 2006 and the precision tube of the lens housing 2004 are precision ground. The polymer washer 2014 restrains the lens 2008 in the floating lens cup 2006 under force from the compression spring 2012. The washer 2014 and the C-ring clip 2016 are used to provide a reaction surface so that the compression spring 2012 can hold the floating lens cup 2006 against the interface with the inner surface of the subassembly tube of the lens housing 2004. The lens housing has notches 2018, 2020 to accommodate use of the tuning wedges 2050, 2052. As discussed below, the tuning wedge 2050, 2052 may be inserted into the notches 2018, 2020 so as to react against the surface in order to push the floating lens cup 2006 in adjustment relative to the mechanical access of the tube of the lens housing 2004.

Next, the array holder 2022 is fit into the precision tube of the lens housing 2004 for a focus adjustment and weld. To accomplish the collimation adjustment, the array holder 2022 and the tube of the lens housing 2004 are installed into the focusing tool (not shown) along with the lens subassembly 2002. The lens subassembly 2002 is aligned and adjusted for optimum collimation. The array holder 2022 is welded to the precision tube of the lens housing 2004. At this point, the lens subassembly 2004 and the fiber array holder subassembly 2003 are a matched pair.

In operation, the collimator assembly 2000 will interface optical signals on an optical fiber with the optics of another optical device by creating a parameter-matched, free space beam; collect a returning beam from the other optical device and re-introduce it into the optical fiber with minimal loss; interface the collimator on the other optical device chassis with accuracy of about +/−25 microns and about +/−1 mR; point the free space beam into the optical access of the other optical device with a coarse adjustment of about +/−2 mR and a fine adjustment of about +/−0.002 mR. Moreover, adhesives are not in the optical path and are not desired for connecting any of the precisely aligned optical/mechanical components.

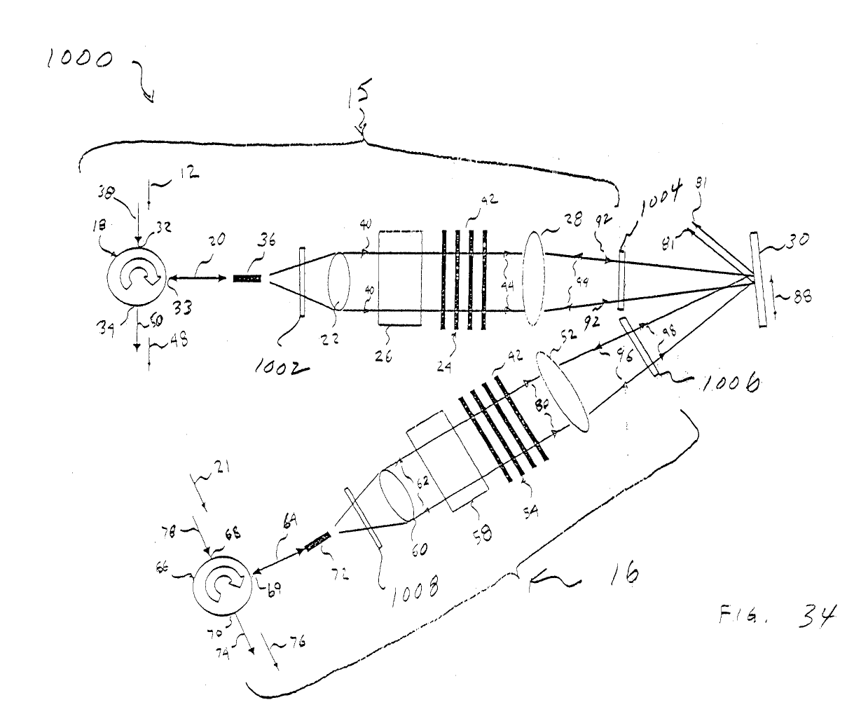

FIG. 34 shows an embodiment of a channel monitor generally indicated as 1000 having optical portions 15, 16 with one or more optical PDL devices 1002, 1004, 1006, 1008 for minimizing polarization dependence loss (PDL). The one or more optical PDL devices 1002, 1008 are arranged between the capillary tube 36 and the grating 24, while the one or more optical PDL devices 1004, 1006 are arranged between the grating 24 and the spatial light modulator 30.

The optical PDL device 1002 may include a polarization splitter for splitting each channel into its pair of polarized light beams and a rotator for rotating one of the polarized light beams of each optical channel. The optical PDL device 1008 may include a rotator for rotating one of the previously rotated and polarized light beams of each optical channel and a polarization splitter for combining the pair of polarized light beams of each channel.

The one or more optical devices 1002, 1004, 1006, 1008 may be incorporated in any of the embodiments shown and described above, including but not limited to the embodiments shown in FIGS. 1, 2, 7A, 7B, 7C, 8, 17, 17A, 23, 27-31 and 33.

In effect, as a person skilled in the art will appreciate, a diffraction grating such as the optical elements 42, 54 has a predetermined polarization dependence loss (PDL) associated therewith. The PDL of the diffraction grating 24 is dependent on the geometry of the etched grooves 42 of the grating. Consequently, means to mitigate PDL may be desired. The λ/4 plate between the spatial light modulator 30 and the diffraction grating(s) 24, 54 (before or after the bulk lens 28, 52) mitigates the PDL for any of the embodiments described hereinbefore. The fast axis of the λ/4 plate is aligned to be approximately 45 degrees to the direction or axis of the lines 42 of the diffraction grating 24. The mirror is angled to reflect the separated channels back through the λ/4 plate to the diffraction grating. In the first pass through the λ/4 plate, the λ/4 plate circularly polarizes the separated light. When the light passes through the λ/4 plate again, the light is linearly polarized to effectively rotate the polarization of the separated channels by 90 degrees. Effectively, the λ/4 plate averages the polarization of the light to reduce or eliminate the PDL. One will appreciate that the λ/4 plate may not be necessary if the diffraction grating has low polarization dependencies, or other PDL compensating techniques are used that are known now or developed in the future.

As shown and described herein, the polarized light beams may have a generally circular cross-section and are imaged at separate and distinct locations on the spatial light modulator 30, such that the polarized light beams of the optical channels do not substantially overlap spatially when focused onto the spatial light modulator, as shown, for example, in FIGS. 6, 18, 25, 34 and 35.

FIG. 35 shows a channel monitor generally indicated as 1600 similar to that shown above, except that the micromirror device is oriented such that the tilt axis 85 is perpendicular to the spectral axis 86. The channel monitor 1600 has a chisel prism 1602 arranged in relation to the spatial light modulator 30, a set of optical components 1604, a retromirror 1605 and a complimentary set of optical components 1606. The underlying configuration of the channel monitor 1600 may be implemented in any of the embodiments show and described in relation to FIGS. 3, 8B, 8C and 18A described above in which the pivot or tilt axis of the mirrors of the micromirror device 30 is perpendicular to the spectral axis of the channels projected on the micromirror device 30.

The set of optical components 1604 and the complimentary set of optical components 1606 are similar to the optical portions 15, 16 shown and described herein. For example, see FIG. 1A. The spatial light modulator 30 is shown and described herein as the well known micromirror device. The chisel prism 1602 has multiple faces, including a front face 1602a, first and second beveled front faces 1602b, a rear face 1602d and a bottom face generally indicated by 1602e. (It is noted that in embodiments having no retroflector or third optical path only two front faces are used, and in embodiments having a retroflector all three front faces are used.) Light from the set of optical components 1604 and the complimentary set of optical components 1606 passes through one or more faces of the chisel prism 1602, reflects off the spatial light modulator back to the chisel prism 1602, reflects off one or more internal surfaces of the chisel prism 1602 and passes back through the chisel prism 1602, passes back to the set of optical components 1604 or the complimentary set of optical components 1606.

The chisel prism design described herein addresses a problem in the optical art when using micromirro devices. The problem is the ability to send a collimated beam out to a reflective object and return it in manner that is insensitive to the exact angular placement of the reflective object. Because a light beam is typically collimated and spread out over a relatively large number of micro-mirrors, any overall tilt of the array causes the returned beam to “miss” the optical component, such as a pigtail, intended to receive the same.

The present invention provides a way to reduce the tilt sensitivity by using a classical optical design that certain combinations of reflective surfaces stabilize the reflected beam angle with respect to angular placement of the reflector. Examples of the classical optical design include a corner-cube (which stabilize both pitch and yaw angular errors) or a dihedral prism (which stabilize only one angular axis.).

One advantage of the configuration of the present invention is that it removes the tilt sensitivity of the optical system (which may comprise many elements besides a simple collimating lens such as element 26 shown and described above) leading up to the retro-reflective spatial light modulator 30. This configuration allows large beam sizes on the spatial light modulator without the severe angular alignment sensitivities that would normally be seen.

Patent application Ser. No. 10/115,647 (CC-0461), which is hereby incorporated by reference, shows and describes the basic principal of these highly stable reflective elements in which all the surfaces of the objects being stable relative to one another, while the overall assembly of the surfaces may be tilted without causing a deviation in reflected angle of the beam that is large compared to the divergence angle of the input beam.

FIG. 36 illustrates a schematic diagram of a channel monitor generally indicated as 1700 having a chisel prism 1704 that provides improved sensitivity to tilt, alignment, shock, temperature variations and packaging profile, which incorporates such a tilt insensitive reflective assembly. The scope of the invention is intended to include using the chisum prism technology described herein in any one or more of the embodiments described herein.

Similar to the embodiments described hereinbefore, and by way of example, the channel monitor 1700 includes a first set of optical components having a dual fiber pigtail 1702 (circulator free operation), the collimating lens 26, a bulk diffraction grating 42, a Fourier lens 34, a 1/4λ plate 35, a reflector 26 and a spatial light modulator 1730 (similar to that shown above). The dual fiber pigtail 601 includes a transmit fiber 1702a and a receive fiber 1702b. The first set of optical components typically provide a first optical input signal having one or more optical bands or channels on the receive fiber 1702b, as well as providing an optical output signal on the transmit fiber 1702b.

Similar to the embodiment described above, the chisel prism 1704 has multiple internally reflective surfaces, including a top surface, and a back surface, as well as transmissive surfaces including a front surface and a bottom surface. The micro-mirror device 1730 is placed normal to the bottom surface of the chisel prism 1704, as shown. In operation, the chisel prism 1704 reflects the first optical input signal from the first set of optical components to the spatial light modulator 1730, and reflects the optical output signal back to the first set of optical components.

The chisel prism 1704 decreases the sensitivity of the optical filter to angular tilts of the optics. The insensitivity to tilt provides a more rugged and robust device to shock vibration and temperature changes. Further, the chisel prism 1704 provides greater tolerance in the alignment and assembly of the optical filter 1700, as well as reduces the packaging profile of the filter. To compensate for phase delay associated with each of the total internal reflection of the reflective surfaces of the prism (which will be described in greater detail hereinafter), a λ/9 wave plate 1708 is optically disposed between the prism 1704 and λ/4 wave plate 35. An optical wedge or lens 1710 is optically disposed between the λ/4 wave plate 35 and the diffraction grating 30 for directing the output beam from the micro-mirror device 1730 to the receive pigtail 1702a of the dual fiber pigtail 1702b. The optical wedge or lens 1710 compensates for pigtail and prism tolerances. The scope of the invention is intended to cover embodiments in which the optical wegde 1710 is arranged parallel or oblique to the front surface of the wedge 1704. Moreover, as shown, these components are only arranged in relation to one front surface; however, as a person skilled in the art would appreciate, these optical components would typically be arranged in relation to any one or more front surfaces shown in FIG. 36, as well as the front surfaces in the other chisel prism embodiments shown ad described herein.

The optical device 1700 further includes a telescope 1712 having a pair of cylindrical lens that are spaced a desired focal length. The telescope 1712 functions as a spatial beam expander that expands the input beam (approximately two times) in the spectral plane to spread the collimated beam onto a greater number of lines of the diffraction grating. The telescope 1712 may be calibrated to provide the desired degree of beam expansion. The telescope advantageously provides the proper optical resolution, permits the package thickness to be relatively small, and adds design flexibility.

A folding mirror 1714 is disposed optically between the Fourier lens 34 and the λ/4 wave plate 35 to reduce the packaging size of the optical filter 1700.

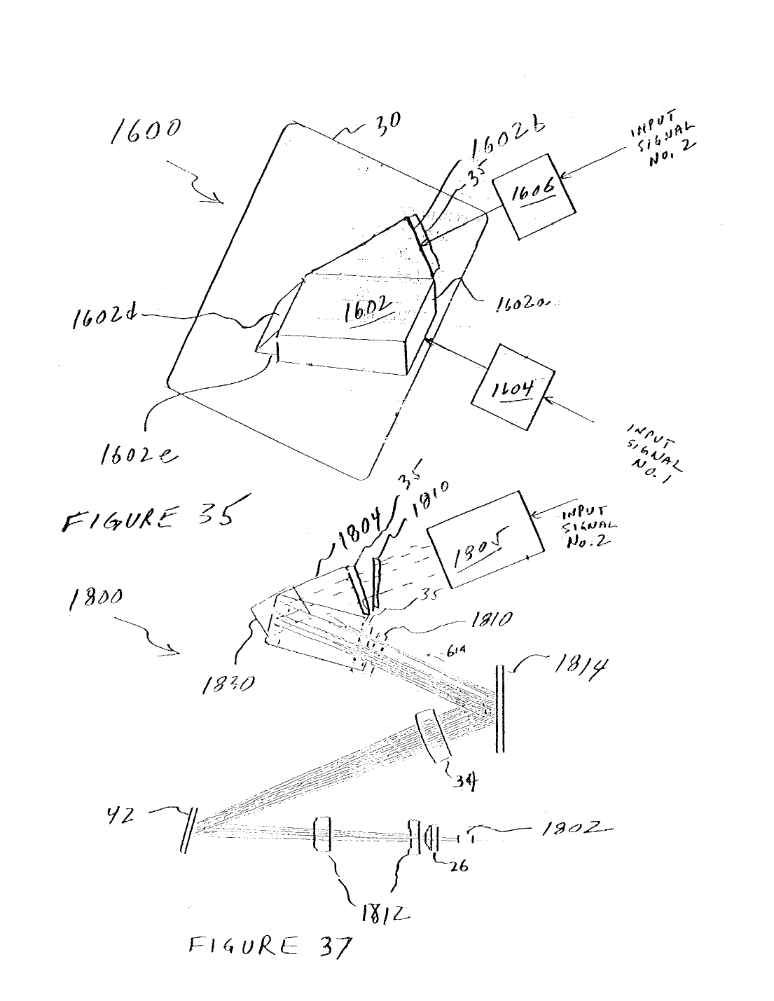

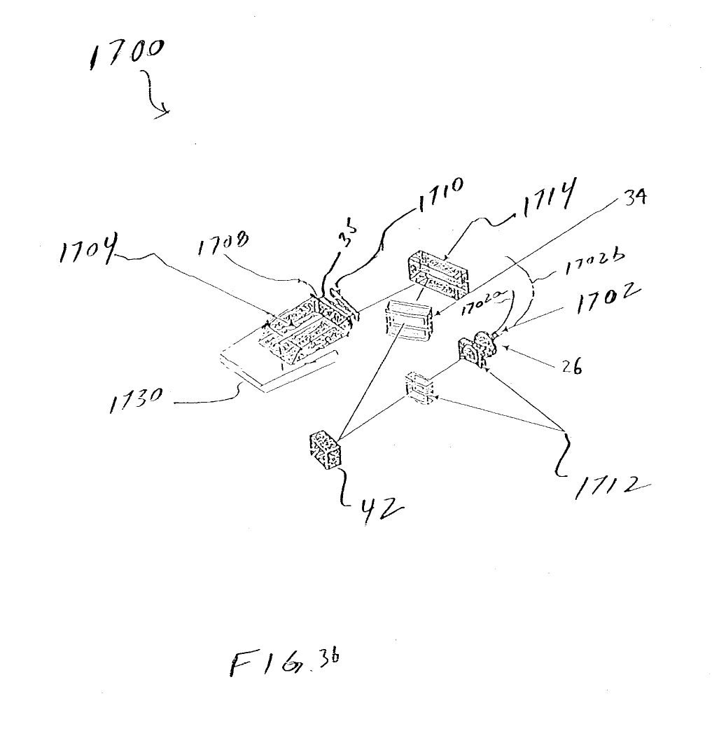

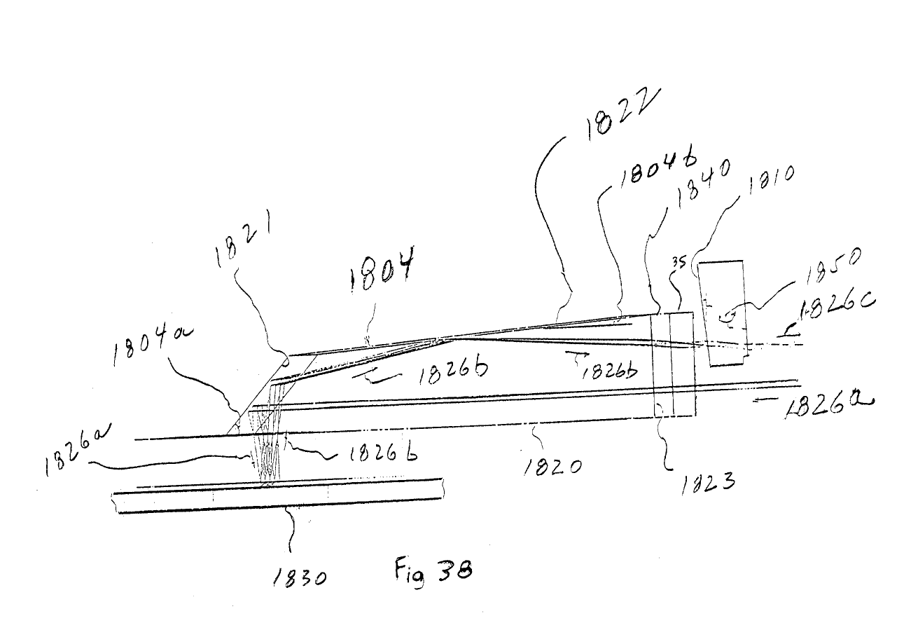

FIG. 37 shows another embodiment of a tilt-insensitive reflective assembly 1800 having a specially shaped prism 1804 arranged in relation to the micro-mirror device 1830, a set of optical components as shown and a compliment set of optical components generally indicated as 1805 consistent with that discussed above.

Unlike an ordinary 45 degree total internal reflection (TIR) prism, in this embodiment the back surface of the chisel prism 1704 is cut at approximately a 48 degree angle relative to the bottom surface of the chisel prism 1704. The top surface of the chisel prism 1704 is cut at a 4 degree angle relative to the bottom surface to cause the light to reflect off the top surface via total internal reflection. The front surface of the chisel prism 1704 is cut at a 90 degree angle relative to the bottom surface. The chisel prism 1704 therefore provides a total of 4 surface reflections in the optical assembly (two TIRs off the back surface, one TIR off the micromirror device 1730, and one TIR off the top surface.)

In order to remove the manufacturing tolerances of the prism angles, a second smaller compensating prism or wedge 1810 (or wedge), having a front surface cut at a shallow angle (e.g., as 10 degrees) with respect to a back surface, may also be used. Slight tilting or pivoting about a pivot point of the compensation wedge 1810 causes the light beam to be pointed in the correct direction for focusing on the receive pigtail 1802.

The combination of the chisel prism 1804 and the compensation wedge 1810 allows for practical fabrication of optical devices that spread a beam out over a significant area and therefore onto a plurality of micromirrors, while keeping the optical system robust to tilt errors introduced by vibration or thermal variations.

In FIG. 38, the input light rays 1826a first pass through the λ/4 wave plate 35 and the λ/9 wave plate 1840. The input rays 1826a reflect off the back surface 1821 of the prism 1804 the micro-mirror device 1830. The rays 1826b then reflect off the micromirror device 1830 back to the back surface 1821 of the prism 1804. The rays 1826b then reflect off the top surface 1822 for a total of 4 surfaces (an even number) and passes through the front surface 1823 of the prism 1804. The rays 1826b then pass back through the λ/4 wave plate 35 and the λ/9 wave plate 1840 to the wedge 1810. The wedge 1810 redirects the output rays 1826c to the receive pigtail 1802. As shown by arrows 1851, the wedge 1810 may be pivoted about its long axis 1850 during assembly to slightly steer the output beam 1826c to the receive pigtail 1802 with minimal optical loss by removing manufacturing tolerances of the chisel prism.

In FIG. 37, the prism 1804 (with wave plates 35, 1840 mounted thereto) and the micro-mirror device 1830 are mounted or secured in fixed relations to each other. The prism 1804 and micro-mirror device 1830 are tilted a predetermined angle off the axis of the input beam 614 (e.g., approximately 9.2 degrees) to properly direct the input beam onto the micromirrors of the micromirror device, as described hereinbefore. The wedge 1810 however is perpendicular to the axis of the input beam 1826a. Consequently, the receive pigtail of the dual fiber pigtail 1802 is rotated a predetermined angle (approximately 3 degrees) from a vertically aligned position with the transmit pigtail. Alternatively, the wedge 1810 may be rotated by the same predetermined angle as the prism and the micromirror device (e.g., approximately 9.2 degrees) from the axis of the input beam. As a result, the receive pigtail of the dual pigtail assembly 1802 may remain vertically aligned with transmit pigtail.

### Scope of the Invention

One will appreciate that each embodiment described hereinbefore and those contemplated by the present invention may function as a tunable single pass or double pass filter, bandpass filter and/or optical drop device by eliminating the optical detector (i.e., photodiode 51).

The dimensions and geometries for any of the embodiments described herein are merely for illustrative purposes and, as much, any other dimensions may be used if desired, depending on the application, size, performance, manufacturing requirements, or other factors, in view of the teachings herein.

It should be understood that, unless stated otherwise herein, any of the features, characteristics, alternatives or modifications described regarding a particular embodiment herein may also be applied, used, or incorporated with any other embodiment described herein. Also, the drawings herein are not drawn to scale.

Although the invention has been described and illustrated with respect to exemplary embodiments thereof, the foregoing and various other additions and omissions may be made therein without departing from the spirit and scope of the present invention.

What is claimed is:

1. An optical channel monitor, comprising:
an optical arrangement having
a light dispersion element for separating an optical input signal into optical bands or channels and for directing one or more reflected optical bands or channels to provide an optical output signal, and
a spatial light modulator having a micro-mirror device with an array of micro-mirrors, a respective group of micro-mirrors selectively reflecting one or more optical bands or channels; and
a light detector for detecting the one or more reflected optical bands or channels in the optical output signal.

2. An optical channel monitor according to claim 1, wherein the one or more light dispersion elements include either a diffraction grating, an optical splitter, a holographic device, a prism, or a combination thereof.

3. An optical channel monitor according to claim 2, wherein the diffraction grating is a blank of polished fused silica or glass with a reflective coating having a plurality of grooves either etched, ruled or suitably formed thereon.

4. An optical channel monitor according to claim 2, wherein the diffraction grating is tilted and rotated approximately 90° in relation to the spatial axis of the dispersed optical output signal.

5. An optical channel monitor according the claim 1, wherein the spatial light modulator is programmable for reconfiguring the optical channel monitor to drop and/or add a desired channel by changing a switching algorithm that drives the array of micro-mirrors.

6. An optical channel monitor according the claim 1, wherein the array of micro-mirrors includes a multiplicity of micro-mirrors that are separately controllable for tilting on an axis depending on a control signal in accordance with a switching algorithm.

7. An optical channel monitor according the claim 1, wherein the one or more optical signals include a wavelength division multiplexed (WDM) optical signal having a plurality of wavelengths and a corresponding plurality of optical bands or channels, each optical channel reflecting off a respective group of micro-mirrors of the micro-mirror device.

8. An optical channel monitor according the claim 1, wherein the spatial light modulator is reconfigurable by statically or dynamically modifying the switching algorithm to accommodate different channel spacing, the shape of the light beam, or the center wavelength of the light beam of optical input signal.

9. An optical channel monitor according the claim 1, wherein the switching algorithm is based on the wavelength of the optical signal and the one or more optical bands or channels being detected.

10. An optical channel monitor according the claim 7, wherein the respective group of micro-mirrors are collectively tilted to reflect channels in the optical input signal.

11. An optical channel monitor according the claim 1, wherein each micro-mirror is tiltable in either a first position or a second position along an axis either substantially parallel to the spectral axis of the optical input signal, substantially parallel to the spatial axis of the optical input signal, or at an angle of 45 degrees in relation to the spatial axis.

12. An optical channel monitor according the claim 1, wherein the optical arrangement includes one or more optical portions that provide the one or more optical signals to the spatial light modulator.

13. An optical channel monitor according the claim 12, wherein the one or more optical portions include either one or more circulators, one or more waveguides, or a combination thereof.

14. An optical channel monitor according the claim 13, wherein the one or more optical portions provide the one or more optical signals to the spatial light modulator.

15. An optical channel monitor according the claim 13, wherein the one or more circulators includes a pair of circulators.

16. An optical channel monitor according the claim 13, wherein the one or more waveguides includes a pair of capillary tubes.

17. An optical channel monitor according the claim 13, wherein the one or more circulators includes a three port circulator.

18. An optical channel monitor according the claim 12, wherein the one or more optical portions include a pair of optical portions, including one optical portion for providing one or more optical signals to the spatial light modulator, and another optical portion for providing an optical signal to be detected to the detector.

19. An optical channel monitor according the claim 12, wherein the one or more optical portions include a collimator, a reflective surface, a dispersion device, a bulk lens, or a combination thereof.

20. An optical channel monitor according the claim 19, wherein the collimator includes either an aspherical lens, an achromatic lens, a doublet, a GRIN lens, a laser diode doublet, or a combination thereof.

21. An optical channel monitor according the claim 19, wherein the reflective surface includes a mirror.

22. An optical channel monitor according the claim 19, wherein the reflective surface is curved.

23. An optical channel monitor according the claim 19, wherein the bulk lens includes a Fourier lens.

24. An optical channel monitor according the claim 12, wherein the one or more optical portions provide the one or more optical as different channels having different wavelengths on the spatial light modulator.

25. An optical channel monitor according the claim 24, wherein the different channels have a desired cross-sectional geometry, including elliptical, rectangular, square or polygonal.

26. An optical channel monitor according the claim 24, wherein the spatial light modulator is configured so one group of channels is spaced at 100 GHz and another group of channels is spaced at 50 GHz.

27. An optical channel monitor according the claim 12, wherein the one or more optical portions further comprise a further optical portion for receiving the one or more optical signals from the spatial light modulator and providing these same optical signals back to the spatial light modulator.

28. An optical channel monitor according the claim 27, wherein the further optical portion includes a single reflective surface and lens arrangement.

29. An optical channel monitor according the claim 28, wherein a single lens is arranged between a reflective surface and the spatial light modulator.

30. An optical channel monitor according to claim 12, wherein the one or more optical portions include one or more optical PDL mitigating devices for minimizing polarization dependence loss (PDL).

31. An optical channel monitor according to claim 30, wherein one optical PDL mitigating device is arranged between a waveguide and a grating in the optical arrangement, and another optical PDL mitigating device is arranged between a grating and the spatial light modulator.

32. An optical channel monitor according to claim 31, wherein the one or more optical PDL mitigating devices include a pair of optical PDL mitigating devices.

33. An optical channel monitor according to claim 31, wherein the one or more optical PDL mitigating devices includes one optical PDL mitigating device having a polarization splitter for splitting each channel into a pair of polarized light beams and a rotator for rotating one of the polarized light beams of each optical channel.

34. An optical channel monitor according to claim 33, wherein the one or more optical PDL mitigating devices includes another optical PDL mitigating device having a rotator for rotating one of the previously rotated and polarized light beams of each optical channel and a polarization splitter for combining the pair of polarized light beams of each channel.

35. An optical channel monitor according to claim 33, wherein the one or more optical PDL mitigating devices includes a λ/4 plate.

36. An optical channel monitor according to claim 2, wherein the diffraction grating has a low PDL.

37. An optical channel monitor according to claim 12, wherein the optical arrangement includes a chisel prism having multiple faces for modifying the direction of the optical input signal.

38. An optical channel monitor according to claim 37, wherein the multiple faces include at least one front face, a rear face, a top face and a bottom face.

39. An optical channel monitor according to claim 37, wherein optical light from first or second optical portions passes through one or more faces of the chisel prism, reflects off one or more internal surfaces of the chisel prism, reflects off the spatial light modulator, again reflects off the one or more internal surfaces of the chisel prism, and passes back to the first or second optical portions.

40. An optical channel monitor according to claim 1, wherein the free optic configuration includes a lens and a grating arranged such that the lens is placed at a distance “d” from the grating that is shorter than focal length “f” of the lens.

41. An optical channel monitor according to claim 1, wherein the free optic configuration includes a lens and a grating arranged such that the lens is placed a distance “d” from the grating that is longer than focal length “f” of the lens.
